(19) United States
(12) Patent Application Publication
(10) Pub. No.: US 2022/0402248 A1
(43) Pub. Date: Dec. 22, 2022

(54) MULTILAYER TOP FILM FOR RETROREFLECTIVE ARTICLES

(71) Applicant: 3M INNOVATIVE PROPERTIES COMPANY, St. Paul, MN (US)

(72) Inventors: Reema Chatterjee, Woodbury, MN (US); Stephen A. Johnson, Woodbury, MN (US); Nathaniel I. Lehn, White Bear Lake, MN (US); Suman K. Patel, Woodbury, MN (US)

(21) Appl. No.: 17/642,783

(22) PCT Filed: Oct. 9, 2020
(86) PCT No.: PCT/IB2020/059525

§ 371 Date: Mar. 14, 2022

Related U.S. Application Data
(60) Provisional application No. 62/914,188, filed on Oct. 11, 2019.

(51) Int. Cl. B32B 27/08; B32B 7/023; B32B 27/30; B32B 27/36; B32B 7/08; B32B 27/18

(52) U.S. Cl. CPC B32B 27/08; B32B 7/023; B32B 27/308; B32B 27/365; B32B 7/08; B32B 27/18; B32B 2270/00; B32B 2250/05; B32B 2250/24; B32B 2250/40; B32B 2307/42; B32B 2307/418; B32B 2307/416; B32B 2307/558; B32B 2307/732; B32B 2307/518; B32B 2551/00

(57) ABSTRACT

The present application generally relates to top films comprising a semi-crystalline core polymeric layer sandwiched by two amorphous skin layers, one on each side of the core polymeric layer. In preferred embodiments, an acrylic layer adjacent one of the amorphous skin layers is present as an outermost layer. The present application is also directed to retroreflective articles comprising such top films.

The present application generally relates to top films comprising a semi-crystalline core polymeric layer sandwiched by two amorphous skin layers, one on each side of the core polymeric layer. In preferred embodiments, an acrylic layer adjacent one of the amorphous skin layers is present as an outermost layer. The present application is also directed to retroreflective articles comprising such top films.

### BACKGROUND

Retroreflective materials are characterized by the ability to redirect incident light towards the originating light source. This property has led to the widespread use of retroreflective sheeting for a variety of traffic and personal safety uses. Retroreflective sheeting is commonly employed in various articles, for example, road signs, barricades, license plates, pavement markers and marking tape, as well as retroreflective tapes for vehicles and clothing.

Two known types of retroreflective sheeting are cube corner sheeting and microsphere-based sheeting. Microsphere-based sheeting, sometimes referred to as “beaded” sheeting, employs a multitude of microspheres typically partially embedded in a binder layer and having associated specular or diffuse reflecting materials (e.g., pigment particles, metal flakes or vapor coats, etc.) to retroreflect incident light. Cube corner retroreflective sheeting, sometimes referred to as “prismatic” sheeting, typically comprises a structured surface comprising a plurality of geometric structures, some or all of which include three reflective faces configured as a cube corner element.

Some flexible prismatic products use flexible and extensible top film, such as EAA, PVC or polyurethanes. Those films, in general, need a carrier film for processing through a manufacturing line, which is eventually removed from the final construction. That removal step adds to the unit cost of the product. Some rigid prismatic products have top films and/or overlay films that, although provide outdoor durability, are nonetheless brittle and lack good in-line processability and suitable end-user handling.

The present disclosure provides low cost multilayer films that can be used as top films for flexible prismatic retroreflective sheeting as well as overlay films for rigid prismatic sheeting

### SUMMARY

The inventors of the present application recognized a need for lower cost, flexible films that have good ink adhesion and are capable of being used as (a) top films for flexible retroreflective sheeting, such as those obtained by cast and cure processes and (b) overlays capable of being laminated to rigid prismatic sheeting.

The inventors recognized that those goals could be achieved by creating a coextruded, biaxially oriented film comprising a core semi-crystalline polymeric layer encapsulated by two amorphous skin polymeric layers, one on each side of the semi-crystalline polymeric layer. In certain preferred embodiments, the film comprises a fourth outermost layer comprising a (meth)acrylate layer located next to one of the amorphous layers.

In some embodiments, the film comprises the following layers in the following order, with each layer being immediately adjacent to the next layer:

a) a first (meth)acrylate layer comprising one or more polymers having a glass transition temperature, Tg, of 80° C. or lower;

b) a first tie layer comprising an amorphous copolymer of polyethylene terephthalate;

c) a core layer comprising a semi-crystalline homopolymer or copolymer of polyethylene terephthalate; and

d) a second tie layer comprising an amorphous copolymer of polyethylene terephthalate.

All scientific and technical terms used herein have meanings commonly used in the art unless otherwise specified. The definitions provided herein are to facilitate understanding of certain terms used frequently in this application and are not meant to exclude a reasonable interpretation of those terms in the context of the present disclosure.

Unless otherwise indicated, all numbers in the description and the claims expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein. At the very least, and not as an attempt to limit the application of the doctrine of equivalents to the scope of the claims, each numerical parameter should at least be construed in light of the number of reported significant digits and by applying ordinary rounding techniques. Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviations found in their respective testing measurements.

The recitation of numerical ranges by endpoints includes all numbers subsumed within that range (e.g. a range from 1 to 5 includes, for instance, 1, 1.5, 2, 2.75, 3, 3.80, 4, and 5) and any range within that range.

When a single value is used for a given property, instead of a range, that value is intended to be represent a range that is ±5% of that value. For example, when referring to a level 20% of impact modifiers in a given layer, the inventors intend to refer to a range from 20% (0.95) to 20%(1.05).

As used in this specification and the appended claims, the singular forms “a”, “an”, and “the” encompass embodiments having plural referents, unless the content clearly dictates otherwise. As used in this specification and the appended claims, the term “or” is generally employed in its sense including “and/or” unless the content clearly dictates otherwise.

The words “preferred” and “preferably” refer to embodiments of the invention that may afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the invention.

The term “adjacent” refers to the relative position of two elements, such as, for example, two layers, that are close to each other and may or may not be necessarily in contact with each other or that may have one or more layers separating the two elements as understood by the context in which “adjacent” appears.

The term “immediately adjacent” refers to the relative position of two elements, such as, for example, two layers, that are next to each other and in contact with each other and have no intermediate layers separating the two elements. The term “immediately adjacent.” In certain preferred embodiments, primers or other surface treatments such as etching, embossing, corona, or plasma treatment, are not present between two immediately adjacent elements.

As used herein, the terms (meth)acrylic or (meth)acrylate refer to both acrylic and methacrylic species and their comonomers.

The term “amorphous polymer” refers to polymers that have a degree of crystallinity that is less than 20%. In some embodiments, the degree of crystallinity is less than 15%. In some embodiments, the degree of crystallinity is less than 10%. In yet other embodiments, the degree of crystallinity is less than 5%. Methods for determining the degree of crystallinity are well known, such as, for example, X-ray diffraction.

The term “semi-crystalline polymer” refers to polymers that have a degree of crystallinity that is 20% or more. In some embodiments, a semi-crystalline polymer has a degree of crystallinity from 20% to 60%, or from 30% to 60%, or from 30% to 50%.

The term “identified melt peak” refers to a peak in a DSC thermograph where the enthalpy is greater than 5 J/g.

The term “average refractive index” refers to the arithmetic average of the refractive index for a material measured in each of the three dimensions x, y, and z.

For a film having a length, a width, and a thickness, where the length and the width define a major surface area in the x-y plane, an “in-plane refractive index” refers to the value of the refractive index measured either in the x-direction or the y-direction.

For a film having a length, a width, and a thickness, where the length and the width define a major surface area in the x-y plane, an “out-of-plane refractive index” refers to the value of the refractive index measured in the z-direction (i.e., along the thickness of the film).

As used herein, the terms “major surface” and “major surfaces” refer to the surface(s) with the largest surface area on a three-dimensional shape having three sets of opposing surfaces.

As used herein, “sheeting” refers to a thin piece of polymeric (e.g. synthetic) material. The sheeting may be of any width and length, such dimension only being limited by the equipment (e.g. width of the tool, width of the slot die orifice, etc.) from which the sheeting was made.

As used herein, “Rq” (or RMS) in the context of surface roughness refers to the root mean square average of height deviations taken from the mean data plane.

As used herein, “Rn” in the context of surface roughness refers to the arithmetic average of the absolute values of the surface height deviations measured from the mean plane.

The above summary is merely intended to provide a cursory overview of the subject matter of the present disclosure and is not intended to describe each disclosed embodiment or every implementation of the present invention. The description that follows more particularly exemplifies illustrative embodiments. In several places throughout the application, guidance is provided through lists of examples, which can be used in various combinations. In each instance, the recited list serves only as a representative group and should not be interpreted as an exclusive list.

### BRIEF DESCRIPTION OF DRAWINGS

FIG. 1 Shows a 4-Layer Co-extruded, biaxially oriented film construction.

FIG. 2 Shows a 5-Layer Co-extruded, biaxially oriented film construction.

FIG. 3 Shows a DSC scan of a comparative PET polyester with a distinct melt point around 250 C and distinct Tg around 80 C for this semi-crystalline polymer.

FIG. 4 Shows a DSC scan of a comparative amorphous co-polyester.

FIG. 5 Shows a DSC scan of a comparative PMMA polymer which we use for extrusion and/or co-extrusion with some films.

FIG. 6 Shows a DSC scan of a comparative CoPMMA polymer which is used for extrusion and co-extrusion with some films.

FIG. 7 Shows a DSC scan of a 4 layered construction (PETg/PET/PETg/CoPMMA) (Example A319130-002).

FIG. 8 Shows a DSC scan of a 4-layered construction (PETg/PET/PETg/CoPMMA) (Example A319130-013).

FIG. 9 Shows a DSC scan of one of our composite 4 layered films (PETg/PET/PETg/CoPMMA) (Example A319131-003).

### DETAILED DESCRIPTION

Various embodiments and implementations will be described in detail in this section. These embodiments and implementations should not be construed as limiting the scope of the present application in any manner, and changes and modifications may be made without departing from the spirit and scope of the disclosure. For example, many of the embodiments, implementations, and examples are discussed with specific reference to retroreflective sheeting, or with reference to typical polymers and copolymers used in the construction of such retroreflective sheeting. However, those exemplary implementations should not be construed to limit the application scope to those embodiments. Further, a few end uses have been discussed herein, but end uses not specifically described herein are included within the scope of the present application. Therefore, the scope of the present application should be determined solely by the claims.

The present application generally relates to top films comprising a semi-crystalline core polymeric layer sandwiched by two amorphous skin layers, one on each side of the core polymeric layer. In preferred embodiments, an acrylic layer adjacent one of the amorphous skin layers is present as an outermost layer. The present application is also directed to retroreflective articles comprising such top films

In addition of being low cost, the top films of the present disclosure provide various advantages of similar known constructions, such as good brightness, good handling properties, outdoor weathering, and printability directly on the outermost layer of the film. The inventors of the instant coextruded films were able to combine the good handling properties of a PET film with outdoor durability of acrylic layers. For instance, the layers in the film have been modified to get good brightness when used in cast and cure micro-replication sheeting. The instant films can also be laminated to existing retroreflective sheeting when used as overlay constructions.

In some embodiments, the film comprises the following layers in the following order, with each layer being immediately adjacent to the next layer:

a) a first acrylic layer;

b) a first tie layer comprising an amorphous copolymer of polyethylene terephthalate;

c) a core layer comprising a semi-crystalline homopolymer or copolymer of polyethylene terephthalate; and

d) a second tie layer comprising an amorphous copolymer of polyethylene terephthalate, and

e) optionally, a second acrylic layer.

In some preferred embodiments, the different layers of the film are coextruded and biaxially oriented.

Acrylic Layers

The acrylic layer comprises acrylic polymers including acrylates, methacrylates, and their copolymers. For ease of description, the present disclosure will use the term (meth)acrylic or (meth)acrylate to refer to compounds or monomers that contain either acrylic and/or methacrylic species or moieties, including comonomers and copolymers. The following disclosure referring to a (meth)acrylate layer is applicable to any acrylic layer present in the film, independently from each other, either the first (meth)acrylate layer and/or the second (meth)acrylate layer.

In some embodiments, the (meth)acrylate layer of the films of the present disclosure comprises one or more (meth)acrylate polymers having a glass transition temperature, Tg, of 80° C. or lower. In other embodiments, the glass transition temperature is from 60° C. to 80° C., or from 70° C. to 80° C., or from 70° C. to 74° C.

In other embodiments, the (meth)acrylate layer has a thickness from 0.2 mils to 1 mil. In certain embodiments, the (meth)acrylate layer has a thickness from 0.2 mils to 1 mil and the film has a width of 36 inches or more, or a thickness from 0.2 mils to 1 mil and the film has a width from 36 inches to 60 inches, or a thickness from 0.2 mils to 1 mil and the film has a width from 48 inches to 52 inches.

In some embodiments, the (meth)acrylate layer comprises alkyl (meth)acrylates. Useful alkyl (meth)acrylates (i.e., acrylic acid alkyl ester monomers) include linear or branched monofunctional unsaturated acrylates or methacrylates of non-tertiary alkyl alcohols, the alkyl groups of which have from 4 to 14 and, in particular, from 4 to 12 carbon atoms. Specific examples of alkyl (meth)acrylate ester monomers include isooctyl acrylate, isononyl acrylate, 2-methyl-butyl acrylate, 2-ethyl-n-hexyl acrylate and n-butyl acrylate, isobutyl acrylate, hexyl acrylate, n-octyl acrylate, n-octyl methacrylate, n-nonyl acrylate, isoamyl acrylate, n-decyl acrylate, isodecyl acrylate, isodecyl methacrylate, isobornyl acrylate, 4-methyl-2-pentyl acrylate and dodecyl acrylate and combinations thereof. In certain preferred embodiments, the acrylates include ethyl-(meth)acrylate and butyl-(meth)acrylate.

The (meth)acrylate layer may also comprise various additives, including one or more compounds chosen from UV absorbers (such as benzotriazoles, benzophenones or triazines), hindered amine light stabilizers, impact modifiers, and fluorescent compounds, such as solvent yellow SY98 and solvent orange SO63. The impact modifiers can be 2-layer or 3-layer shells with 18% to 60% loading. In certain embodiments, the loading of impact modifiers is from 20% to 60%, or from 25% to 60%, or from 25% to 55% or from 25% to 50%, or from 25% to 40%, or from 25% to 30%, or from 30% to 60%, or from 30% to 55% or from 30% to 50%, or from 30% to 40%.

In certain embodiments, the first (meth)acrylate layer, the second (meth)acrylate layer, or both comprise(s), independently from each other, an ABA block copolymer with polymethylmethacrylate (PMMA) end blocks and a poly (n-butyl acrylate) (PnBA) mid-block.

In certain embodiments, the first (meth)acrylate layer, the second (meth)acrylate layer, or both comprise(s), independently from each other, an ABA block copolymer with polymethylmethacrylate (PMMA) end blocks and a poly (n-butyl acrylate) (PnBA) mid-block, wherein the concentration (w/w) of the ABA block copolymer is chosen from 1% to 25%, from 1% to 20%, from 1% to 15%, from 1% to 13%, from 1% to 10%, 3% to 25%, from 3% to 20%, 3% to 15%, from 3% to 13%, from 3% to 10%, from 5% to 25%, from 5% to 20%, 5% to 15%, from 5% to 13%, from 5% to 10%, from 10% to 25%, from 10% to 20%, 10% to 15%, from 10% to 13%, from 15% to 25%, and from 15% to 20%.

In other embodiments, the first (meth)acrylate layer, the second (meth)acrylate layer, or both comprise(s), independently from each other, an ABA block copolymer with polymethylmethacrylate (PMMA) end blocks and a poly (n-butyl acrylate) (PnBA) mid-block, wherein neither the first (meth)acrylate layer nor the second (meth)acrylate layer comprise impact modifiers.

In other embodiments, the first (meth)acrylate layer, the second (meth)acrylate layer, or both comprise(s), independently from each other, an ABA block copolymer with polymethylmethacrylate (PMMA) end blocks and a poly (n-butyl acrylate) (PnBA) mid-block, wherein the first (meth)acrylate layer and the second (meth)acrylate layer, independently from each other, comprise impact modifiers at a loading (w/w) chosen from: 18% to 60%, 20% to 60%, 25% to 60%, 25% to 55%, 25% to 50%, 25% to 40%, 25% to 30%, 30% to 60%, 30% to 55%, 30% to 50%, 30% to 40%, 20%, 30%, 40%, 50%, and 55%. In these embodiments, the concentration (w/w) of the ABA block copolymer is chosen, independently from the concentration of impact modifiers in each layer, from 1% to 25%, from 1% to 20%, from 1% to 15%, from 1% to 13%, from 1% to 10%, 3% to 25%, from 3% to 20%, 3% to 15%, from 3% to 13%, from 3% to 10%, from 5% to 25%, from 5% to 20%, 5% to 15%, from 5% to 13%, from 5% to 10%, from 10% to 25%, from 10% to 20%, 10% to 15%, from 10% to 13%, from 15% to 25%, and from 15% to 20%

UV absorbers (UVAs) are used in retroreflective sheeting to, for example, protect films containing optical layers from the harmful radiation of the sun in the solar light spectrum (between about 290 nm and 400 nm). Some exemplary UVA materials are described in, for example, U.S. Pat. No. 5,450,235 (Smith et al) and PCT Publication No. 2012/135595 (Meitz et al), both of which are incorporated in their entirety herein.

Core Layer

The core layer comprises a semi-crystalline homopolymer or copolymer of polyethylene terephthalate. Without being limited by theory, the core layer provides the dimensional stability necessary for the film of the present disclosure to be flexible and have good handling properties.

For instance, the core layer, via the second tie layer comprising an amorphous polymer, can serve to support a layer comprising cube corner elements. That is, in certain embodiments, the cube corner layer is attached or immediately adjacent the second tie layer, which is being supported by the core layer.

In some embodiments, the core layer comprises a homopolymer or copolymer of polyethylene terephthalate having an identified melt peak in the range from 240° C. to 265° C.

In other embodiments, the core layer comprises a homopolymer or copolymer of polyethylene terephthalate having a refractive index in-plane in at least one direction (x or y, or both directions) from 1.60 to 1.72, and a refractive index out-of-plane (z direction) from 1.47 to 1.55, or a refractive index in-plane in at least one direction (x or y, or both directions) from 1.63 to 1.67 and a refractive index out of plane (z direction) from 1.48 to 1.51, or a refractive index in-plane in at least one direction (x or y, or both directions) from 1.64 to 1.66 and a refractive index out of plane (z direction) from 1.48 to 1.50, or a refractive index in-plane in at least one direction (x or y, or both directions) of about 1.65 and a refractive index out of plane (z direction) of about 1.49.

In yet other embodiments, the core layer comprises a homopolymer or copolymer of polyethylene terephthalate, wherein the difference in refractive index between the in-plane directions (x-y directions) is less than 0.05 and the difference between any in-plane direction and the out-of-plane direction (x-z and y-z directions) is greater than or equal to 0.10, or from 0.10 to 0.25, or from 0.12 to 0.20, or from 0.14 to 0.18, or from 0.15 to 0.17, or about 0.16.

In some embodiments, the core layer is relatively stiff, by which is meant that the core layer comprises a homopolymer or copolymer of polyethylene terephthalate having an elastic modulus of equal to or greater than 1750 MPa; or equal to or greater than 2000 MPa, or equal to or greater than 2300 MPa; or equal to or greater than 2500 MPa, or equal to or greater than 2700 MPa; or equal to or greater than 3000 MPa. The term “elastic modulus” means the elastic modulus determined according to the test described in the “Examples” section below for elastic modulus using Atomic Force Microscopy (AFM).

In other embodiments, the core layer has a thickness from 0.5 mils to 5 mils, or from 0.75 mils to 3 mils, or from 1 mils to 2 mils.

In some embodiments, the core layer includes one or more light transmitting or transparent polymeric materials. In general, the polymer of the core layer comprises carboxylate comonomer units and glycol comonomer units. In some embodiments, the core layer may itself include more than one layer. In some embodiments where the core layer includes multiple layers, these layers can include more than one composition, and the composition can vary by layer.

In some embodiments, the polymer of the core layer comprises carboxylate comonomer units chosen from terephthalic acid; isophthalic acid; 2,6-naphthalene dicarboxylic acid and isomers thereof and the glycol comonomer units chosen from ethylene glycol; propylene glycol; 1,4-butanediol and isomers thereof; 1,6-hexanediol; neopentyl glycol; diethylene glycol; tricyclodecanediol; 1,4-cyclohexanedimethanol and isomers thereof. In certain embodiments, the core layer comprises polyethylene terephthalate homopolymer.

The core layer may also comprise various additives, including one or more compounds chosen from UV absorbers (such as benzotriazoles, benzophenones or triazines), hindered amine light stabilizers, impact modifiers, and fluorescent compounds, such as solvent yellow SY98 and solvent orange SO63. The impact modifiers can be 2-layer or 3-layer shells with a loading as described previously in the section for acrylic layers.

Amorphous Layers

The films of the present disclosure include a couple of tie layers, one on each side of the core layer. Each of the tie layers comprise, independently of each other, an amorphous copolymer of polyethylene terephthalate.

In general, as mentioned before, the degree of crystallinity of a polymer is often used as a measure of the amorphous nature of the polymer. As used herein, the term “amorphous” or “amorphous polymer” refers to polymers where the degree of crystallinity is less than 20%. In some embodiments, the degree of crystallinity is less than 15%. In some embodiments, the degree of crystallinity is less than 10%, or less than 5%.

The following disclosure referring to a tie layer is applicable to any tie present in the film, independently from each other, either the first tie layer and/or the second tie layer.

In some embodiments, the tie layer comprises a copolymer of polyethylene terephthalate not having an identified melt peak in the range from 240° C. to 265° C.

In other embodiments, a tie layer comprises copolymer of polyethylene terephthalate having an average refractive index from 1.50 to 1.61, or from 1.52 to 1.59, or from 1.56 to 1.57.

In yet other embodiments, a tie layer comprises a copolymer of polyethylene terephthalate, wherein the differences in refractive index between any two directions (x-y, x-z, or y-z) is less than 0.05, or less than 0.025, or less than 0.02.

In some embodiments, the tie layer comprises an copolymer of polyethylene terephthalate and having a thickness from 0.1 mils to 1 mil, or from 0.1 mils to 0.5 mils.

In some embodiments, the tie layer comprises a copolymer of polyethylene terephthalate having an elastic modulus of less than 2000 MPa, or less than 1750 MPa, or less than 1500 MPa, or less than 1300 MPa, or less than 1100 MPa, or less than 1000 MPa.

In other embodiments, the tie layer comprises a reaction product of one or more polyol comonomers and one or more dicarboxylic acid comonomers, wherein the polyol comonomers are chosen from polyols having branched C4-C10 alkyl units and polyols having cyclic C4-C10 alkyl units and the dicarboxylic acid comonomer comprise terephthalate and/or naphthalate subunits.

For instance, exemplary polymers for use in the tie layer include an amorphous copolymer of poly(ethylene terephthalate) and poly(ethylene naphthalene dicarboxylate); poly(ethylene terephthalate) copolyester containing 1,4-cyclohexanedimethanol (PETG copolyester); poly(ethylene naphthalenedicarboxylate) copolyester containing 1,4-cyclohexanedimethanol (PEN copolyester); polycyclohexylendimethylene terephthalate glycol (PCTG), poly(1,4-cyclohexylenedimethylene-1,4-cyclohexane dicarboxylate) (PCCD), isophthalate copolymer, copolyester ether (such as, for example, Eastman NEOSTAR™ elastomers FN005, FN006, and FN007 and ECDEL™ elastomers 9965, 9966, and 9967 (also described in U.S. Patent Publication No. 20090130606144 (Bacon))), 80/20 CoPET (terephthalate/isophthalate), and PET/CoPET (60/40 terephthalic acid/sebacic acid CoPET)). In some embodiments, the tie layer does not include a homopolymer of poly(ethylene terephthalate).

In other preferred embodiments, the tie layer comprises a reaction product of one or more polyol comonomer and one or more dicarboxylic acid comonomer, wherein the polyol comonomers are chosen from ethylene glycol, neopentyl glycol, and cyclohexane dimethanol and the dicarboxylic acid comonomers are chosen from isophthalate, sodiumsulfoisophthalate, naphthalate, and terephthalate subunits.

In other embodiments, an amorphous tie layer has a softening point of between about 45° C. and 160° C. The softening point is measured by Nano thermal analysis with AFM (Atomic Force microscopy) as defined in Anasys Instruments, Nano TATM: Nano Thermal analysis, application note #3, “Multilayer Biaxially Oriented Polypropylene (BOPP) Films,” authors: Nicolaas-Alexander Gotzen, Guy Van Assche.

A tie layer may also comprise various additives, including one or more compounds chosen from UV absorbers, hindered amine light stabilizers, impact modifiers, and fluorescent compounds, such as solvent yellow SY98 and solvent orange SO63.

In other embodiments, wherein the Rq of the surface of the outermost (meth)acrylate layer is chosen from higher than 0.4 nm, from 0.4 nm to 0.7 nm, from 0.4 nm to 0.65 nm, and from 0.4 nm to 0.6 nm.

In other embodiments, the Ra of the surface of the outermost (meth)acrylate is chosen from higher than 0.3 nm, from 0.3 nm to 0.6 nm, from 0.3 nm to 0.55 nm, from 0.3 nm to 0.5 nm, from 0.3 nm to 0.45 nm, from 0.35 nm to 0.6 nm, from 0.35 nm to 0.55 nm, from 0.35 nm to 0.5 nm, and from 0.35 nm to 0.45 nm.

In other embodiments, independently from each other, the Rq of the surface of the outermost (meth)acrylate is chosen from higher than 0.4 nm, from 0.4 nm to 0.7 nm, from 0.4 nm to 0.65 nm, and from 0.4 nm to 0.6 nm and the Ra of the surface of the outermost (meth)acrylate is chosen from higher than 0.3 nm, from 0.3 nm to 0.6 nm, from 0.3 nm to 0.55 nm, from 0.3 nm to 0.5 nm, from 0.3 nm to 0.45 nm, from 0.35 nm to 0.6 nm, from 0.35 nm to 0.55 nm, from 0.35 nm to 0.5 nm, and from 0.35 nm to 0.45 nm.

In certain preferred embodiments, the Rq (nm) of the surface of the outermost (meth)acrylate is higher than 0.4 nm, more preferably from 0.4 nm to 0.65 nm and the Ra of the surface of the outermost (meth)acrylate is preferably higher than 0.35 nm, more preferably from 0.35 nm to 0.55 nm.

Articles and Additional Components

Some embodiments include a retroreflective film comprising a film of the present disclosure and a prismatic layer cube corner elements.

In some embodiments, the cube corner elements are discrete truncated cube corner elements. Generally, truncated cube corner elements have the base edges of two adjacent cube corner element arrays substantially coplanar. In some embodiments, truncated cube corner elements include a series of grooves that are formed in the surface of a planar substrate (e.g., metal plate) to form a master mold comprising a plurality of truncated cube corner elements. In one well known technique, three sets of parallel grooves intersect each other at 60 degree included angles to form an array of cube corner elements, each having an equilateral base triangle (see, e.g., U.S. Pat. No. 3,712,706 (Stamm), incorporated in its entirety herein). In another technique, two sets of grooves intersect each other at an angle greater than 60 degrees and a third set of grooves intersects each of the other two sets at an angle less than 60 degrees to form an array of canted cube corner element matched pairs (see e.g., U.S. Pat. No. 4,588,258 (Hoopman), incorporated in its entirety herein).

Discrete cube corner elements are not fused or connected to an adjacent individual cube corner element. Instead, adjacent discrete truncated cube corner elements are separate from one another. In some embodiments, the discrete truncated cube corner elements have a height of between about 1.8 mils and about 2.5 mils

The truncated cube corner elements can include any desired materials, including those described in, for example, U.S. Pat. No. 3,712,706 or 4,588,258, both of which are incorporated in their entirety. Some exemplary materials for use in the discrete truncated cube corner elements include, for example, polymerizable resins. Exemplary polymerizable resins suitable for forming the array of cube corner elements may be blends of photoinitiator and at least one compound bearing an acrylate group. In some embodiments, the resin blend contains a monofunctional, a difunctional, or a polyfunctional compound to ensure formation of a crosslinked polymeric network upon irradiation.

Illustrative examples of resins that are capable of being polymerized by a free radical mechanism that can be used in the embodiments described herein include acrylic-based resins derived from epoxies, polyesters, polyethers, and urethanes, ethylenically unsaturated compounds, isocyanate derivatives having at least one pendant acrylate group, epoxy resins other than acrylated epoxies, and mixtures and combinations thereof. U.S. Pat. No. 4,576,850 (Martens) discloses examples of crosslinked resins that may be used in cube corner element arrays with films of the present disclosure. Polymerizable resins of the type disclosed in, for example, U.S. Pat. No. 7,611,251 (Thakkar) may be used in cube corner element arrays of the present disclosure.

The discrete truncated cube corner elements can be composite cube corner elements, as described in, for example, PCT Publication No. WO 2012/166460 (Benson et al), incorporated in its entirety herein. Composite truncated cube corner elements include a first resin in a first region of a cube corner element and a second resin in a second region in that cube corner element. Whichever of the first or second resin is directly adjacent to the polymeric layer can be the same or different than the polymeric layer. The plurality of cube corner elements can also be any other type of cube corner element plurality described in PCT Publication No. WO 2012/166460, incorporated in its entirety herein.

Some embodiments include a specular reflective coating, such as a metallic coating, on the discrete truncated cube corner elements. These embodiments are often referred to as “metalized retroreflective sheeting.” The specular reflective coating can be applied by known techniques such as vapor depositing or chemically depositing a metal such as aluminum, silver, or nickel. A primer layer may be applied to the backside of the cube corner elements to promote the adherence of the specular reflective coating. Additional information about metalized sheeting, including materials used to make metalized sheeting and methods of making it can be found, for example, in U.S. Pat. No. 4,801,193 (Martin) and U.S. Pat. No. 4,703,999 (Benson), both of which are incorporated herein in their entirety.

In some embodiments, one or more sealing layers (also referred to, in the singular, as seal film or sealing film or seal layer) may be used on the retroreflective articles of the present application. The sealing layer(s) can include any of the materials mentioned in, for example, U.S. Pat. No. 4,025,159 (McGrath), U.S. Pat. No. 7,611,251 (Thakkar et al), and U.S. Patent Publication No. 2013/114143 (Thakkar et al) all of which are incorporated by reference in their entirety. In some embodiments, the sealing layer(s) is structured, as described in, for example, U.S. Patent Application No. 61/838,562, which is incorporated by reference herein in its entirety.

Some embodiments include a plurality of individual seal legs that extend between the discrete truncated cube corner elements and a multilayer seal film. In some embodiments, these seal legs form one or more cells. A low refractive index material (e.g., a gas, air, aerogel, or an ultra low index material described in, for example, U.S. Patent Publication No. 2010/0265584 (Coggio et al)) can be enclosed in each cell. The presence of the low refractive index material creates a refractive index differential between the discrete truncated cube corner elements and the low refractive index material. This permits total internal reflection at the surfaces of the discrete truncated cube corner elements. In embodiments where air is used as the low refractive index material, the interface between the air and the discrete truncated cube corner elements is often referred to as an air interface.

In some embodiments, the sealing layer is a multilayer film that includes the layers described in, for example, PCT Publication WO 2011/091132 (Dennison et al) (incorporated herein in its entirety) with specific reference to FIG. 2 and related description as the sealing layer, adhesive layer 28, and the release and liner layers 30 and 32. In some embodiments, the multilayer film includes the layers described in WO 2011/091132 with specific reference to film 20 with a sealing layer instead of a receptor layer 22. In such instances, the sealing layer would be on core layer 24, and primer layer 26 is on core layer 24, opposite sealing layer. Multilayer film 20 from WO 2011/091132 additionally includes: an adhesive layer 28 on primer layer 26 opposite core layer 24; release layer 32 on adhesive layer 28 opposite primer layer 26; and liner layer 32 on release layer 30 opposite adhesive layer 28. The multilayer film can generally be separated along the interface between adhesive layer 28 and release layer 30.

In some embodiments, the retroreflective sheeting lacks either sealing films and/or a specular reflective or metal coating on the cube corner elements. Exemplary sheeting constructions are described in, for example, in U.S. Patent Publication No. 2013/0034682 (Free et al), incorporated herein in its entirety. In these embodiments, the retroreflective sheeting comprises optically active areas in which incident light is retroreflected by a structured surface including, for example, cube corner elements, and one or more optically inactive areas in which incident light is not substantially retroreflected by the structured surface. The one or more optically active areas include a low refractive index layer or material adjacent to a portion of the structured surface. The one or more optically inactive areas include a pressure sensitive adhesive adjacent to a portion of the structured surface. The pressure sensitive adhesive substantially destroys the retroreflectivity of the portions of the structured surface that are directly adjacent thereto. The low refractive index layer assists in maintaining the retroreflectivity of the adjacent structured surface by forming a “barrier” between the structured surface and the pressure sensitive adhesive. In some embodiments, the retroreflective sheeting includes a barrier layer between the pressure sensitive adhesive and the low refractive index layer. The barrier layer has sufficient structural integrity to substantially prevent flow of the pressure sensitive adhesive into the low refractive index layer. Exemplary materials for the barrier layer include resins, polymeric materials, inks, dyes, and vinyls. In some embodiments, the barrier layer traps a low refractive index material in the low refractive index layer. Low refractive index materials are materials that have an index of refraction that is less than 1.3 (e.g., air and low index materials (e.g., low refractive index materials described in U.S. Patent Publication No. 2012/0038984 (Patel et al), which is hereby incorporated herein in its entirety). In some embodiments, the retroreflective sheeting includes a pressure sensitive adhesive layer that contacts at least some of the discrete truncated cube corner elements. The pressure sensitive adhesive layer comprises at least one discrete barrier layer. In some embodiments, the pressure sensitive adhesive comprises a plurality of discrete barrier layers.

Various methods may be used to form a retroreflective article as described above. Some methods involve: (1) providing a substrate comprising: (a) a body layer; and (b) a polymeric layer including a substantially amorphous polymeric layer; and (2) forming a plurality of discrete truncated cube corner elements on the polymeric layer of the substrate. In some embodiments, these methods involve cast and cure processing, as is described in, for example, U.S. Pat. No. 3,689,346 (Rowland) and U.S. Pat. No. 5,691,846 (Benson et al), both of which are incorporated in their entirety herein.

Some methods further include forming a specular reflective coating on the discrete truncated cube corner elements. The specular reflective coating can be applied by known techniques such as vapor depositing or chemically depositing a metal. Additional details about such methods are provided in, for example, U.S. Pat. No. 4,801,193 (Martin) and U.S. Pat. No. 4,703,999 (Benson), both of which are incorporated herein in their entirety. Alternatively, some methods include using a sealing layer in lieu of the specular reflective coating or using a pressure sensitive adhesive layer comprising discrete barrier materials.

The retroreflective articles made with films of the present disclosure have many uses. Some exemplary uses include highway or street signage articles, license plate sheeting, personal safety devices, personal safety clothing, conspicuity applications, vehicle warning, canvas coatings, and the like. In some embodiments, the retroreflective article is one of a highway signage article, a street signage article, a license plate sheeting, a license plate, a personal safety device, personal safety clothing, a conspicuity article, a vehicle warning article, or a canvas coating article. Where the retroreflective article is used as sheeting, some exemplary substrates to which the retroreflective sheeting can be adhered include, for example, wood, aluminum sheeting, galvanized steel, polymeric materials (e.g., polymethyl methacrylates, polyesters, polyamids, polyvinyl fluorides, polycarbonates, polyvinyl chlorides, polyurethanes), and a wide variety of laminates made from these and other materials.

The retroreflective articles of the present disclosure have various advantages and/or benefits. For example, many embodiments of the retroreflective articles exhibit excellent flexibility. In at least some embodiments, the articles are bendable but not extensible. This flexibility is especially desirable for certain retroreflective sheeting applications, including, for example, barrel wrapping, truck conspicuity, and the like. Additionally, some embodiments of the retroreflective articles of the present disclosure are mechanically durable in terms of their ability to recover from repeated or extended periods of severe distortion and/or distortional flex while, at the same time, are capable of maintaining superior optical properties as defined by efficiency of retroreflection and superior appearance. Also, the retroreflective articles are able to withstand long term exposure to wear and weathering without significant degradation of optical properties or retroreflective brightness. Also, the retroreflective articles have excellent retroreflectivity. Some articles have a brightness of at least 250 candela/lux/m2. Some articles have a brightness of at least 600 candela/lux/m2, or at least 1000 candela/lux/m2.

Typically, the thickness of retroreflective sheeting typically ranges from about 0.004 inches (0.1016 mm) to about 0.10 inches (2.54 mm). In general, dimensions in this application will be used in indistinctly in inches, millimeters, or thousands of an inch, commonly known as “mils.” In some embodiments, the thickness of retroreflective sheeting is less than about 0.012 inches (0.3048 mm). In some embodiments, the thickness of retroreflective sheeting is less than about 0.010 inches (0.254 mm). In the case of retroreflective sheeting, the width is typically at least 12 inches (30 cm). In some embodiments, the width is at least 48 inches (76 cm). In some embodiments, the sheeting is continuous in its length for up to about 50 yards (45.5 m) to 100 yards (91 m) such that the sheeting is provided in a conveniently handled roll-good. Alternatively, however, the sheeting may be manufactured as individual sheets rather than as a roll-good. In such embodiments, the sheets preferably correspond in dimensions to the finished article. For example, the retroreflective sheeting, may have the dimensions of a standard U.S. sign (e.g., 30 inches by 30 inches (76 cm by 76 cm) and thus the microstructured tool employed to prepare the sheeting may have about the same dimensions.

### EXEMPLARY EMBODIMENTS

1. A film comprising, the following layers in the following order, with each layer being immediately adjacent to the next layer:
   a) a first (meth)acrylate layer comprising one or more polymers having a glass transition temperature, Tg, of 80° C. or lower;
   b) a first tie layer comprising an amorphous copolymer of polyethylene terephthalate;
   c) a core layer comprising a semi-crystalline homopolymer or copolymer of polyethylene terephthalate;
   d) a second tie layer comprising an amorphous copolymer of polyethylene terephthalate;

wherein the film is coextruded and biaxially oriented.
2. A film comprising, the following layers in the following order, with each layer being immediately adjacent to the next layer:
   a) a first (meth)acrylate layer comprising one or more polymers having a glass transition temperature, Tg, of 80° C. or lo-wer;
   b) a first tie layer comprising a copolymer of polyethylene terephthalate not having an identified melt peak in the range from 240° C. to 265° C.;
   c) a core layer comprising a homopolymer or copolymer of polyethylene terephthalate having an identified melt peak in the range from 240° C. to 265° C.,
   d) a second tie layer comprising a copolymer of polyethylene terephthalate not having an identified melt peak in the range from 240° C. to 265° C.;

wherein the film is coextruded and biaxially oriented.
3. A film comprising, the following layers in the following order, with each layer being immediately adjacent to the next layer:
   a) a first (meth)acrylate layer comprising one or more polymers having a glass transition temperature, Tg, of 80° C. or lower;
   b) a first tie layer comprising a copolymer of polyethylene terephthalate having an average refractive index from 1.50 to 1.61;
   c) a core layer comprising a homopolymer or copolymer of polyethylene terephthalate having a refractive index in-plane in at least one direction (x or y, or both directions) from 1.60 to 1.72, and a refractive index out-of-plane (z direction) from 1.47 to 1.55,
   d) a second tie layer comprising a copolymer of polyethylene terephthalate having an average refractive index from 1.50 to 1.61;

wherein the film is coextruded and biaxially oriented.
4. A film comprising, the following layers in the following order, with each layer being immediately adjacent to the next layer:
   a) a first (meth)acrylate layer comprising one or more polymers having a glass transition temperature, Tg, of 80° C. or lower;
   b) a first tie layer comprising a copolymer of polyethylene terephthalate, wherein the differences in refractive index between any two directions (x-y, x-z, or y-z) is less than 0.05;
   c) a core layer comprising a homopolymer or copolymer of polyethylene terephthalate, wherein the difference in refractive index between the in-plane directions (x-y directions) is less than 0.05 and the difference between any in-plane direction and the out-of-plane direction (x-z and y-z directions) is greater than or equal to 0.10,
   d) a second tie layer comprising a copolymer of polyethylene terephthalate, wherein the differences in refractive index between any two directions (x-y, x-z, or y-z) is less than 0.05;

wherein the film is coextruded and biaxially oriented.
5. A film comprising, the following layers in the following order, with each layer being immediately adjacent to the next layer:
   a) a first (meth)acrylate layer comprising one or more polymers having a glass transition temperature, Tg, of 80° C. or lower;
   b) a first tie layer comprising a copolymer of polyethylene terephthalate, wherein the differences in refractive index between any two directions (x-y, x-z, or y-z) is less than 0.05;
   c) a core layer comprising a homopolymer or copolymer of polyethylene terephthalate, wherein the difference in refractive index between the in-plane directions (x-y directions) is less than 0.05 and the difference between any in-plane direction and the out-of-plane direction (x-z and y-z directions) is from 0.10 to 0.25,
   d) a second tie layer comprising a copolymer of polyethylene terephthalate, wherein the differences in refractive index between any two directions (x-y, x-z, or y-z) is less than 0.05;
   wherein the film is coextruded and biaxially oriented.
6. A film comprising, the following layers in the following order, with each layer being immediately adjacent to the next layer:
   a) a first (meth)acrylate layer comprising one or more polymers having a glass transition temperature, Tg, of 80° C. or lower;
   b) a first tie layer comprising a copolymer of polyethylene terephthalate having an elastic modulus of less than 1750 MPa;
   c) a core layer comprising a homopolymer or copolymer of polyethylene terephthalate having an elastic modulus of equal to or greater than 1750 MPa;
   d) a second tie layer comprising a copolymer of polyethylene terephthalate having an elastic modulus of less than 1750 MPa;

wherein the film is coextruded and biaxially oriented.
7. A film comprising, the following layers in the following order, with each layer being immediately adjacent to the next layer:
   a) a first (meth)acrylate layer comprising one or more polymers having a glass transition temperature, Tg, of 80° C. or lower;
   b) a first tie layer comprising a copolymer of polyethylene terephthalate having an elastic modulus of less than 2000 MPa;
   c) a core layer comprising a homopolymer or copolymer of polyethylene terephthalate having an elastic modulus of equal to or greater than 2000 MPa;
   d) a second tie layer comprising a copolymer of polyethylene terephthalate having an elastic modulus of less than 2000 MPa;

wherein the film is coextruded and biaxially oriented.
8. A film comprising, the following layers in the following order, with each layer being immediately adjacent to the next layer:
   a) a first (meth)acrylate layer comprising one or more polymers having a glass transition temperature, Tg, of 80° C. or lower;
   b) a first tie layer comprising an amorphous copolymer of polyethylene terephthalate and having a thickness from 0.1 mils to 1 mil;
   c) a core layer comprising a semi-crystalline homopolymer or copolymer of polyethylene terephthalate;
   d) a second tie layer comprising an amorphous copolymer of polyethylene terephthalate and having a thickness from 0.1 mils to 1 mil;

wherein the film is coextruded and biaxially oriented.
9. A film comprising, the following layers in the following order, with each layer being immediately adjacent to the next layer:
   a) a first (meth)acrylate layer comprising one or more polymers having a glass transition temperature, Tg, of 80° C. or lower;
   b) a first tie layer comprising a copolymer of polyethylene terephthalate not having an identified melt peak in the range from 240° C. to 265° C., and having a thickness from 0.1 mils to 1 mil;
   c) a core layer comprising a homopolymer or copolymer of polyethylene terephthalate having an identified melt peak in the range from 240° C. to 265° C.,
   d) a second tie layer comprising a copolymer of polyethylene terephthalate not having an identified melt peak in the range from 240° C. to 265° C., and having a thickness from 0.1 mils to 1 mil;

wherein the film is coextruded and biaxially oriented.
10. A film comprising, the following layers in the following order, with each layer being immediately adjacent to the next layer:
   a) a first (meth)acrylate layer comprising one or more polymers having a glass transition temperature, Tg, of 80° C. or lower;
   b) a first tie layer comprising a copolymer of polyethylene terephthalate having an average refractive index from 1.50 to 1.61, and having a thickness from 0.1 mils to 1 mil;
   c) a core layer comprising a homopolymer or copolymer of polyethylene terephthalate having a refractive index in-plane in at least one direction (x or y, or both directions) from 1.60 to 1.72, and a refractive index out-of-plane (z direction) from 1.47 to 1.55,
   d) a second tie layer comprising a copolymer of polyethylene terephthalate having an average refractive index from 1.50 to 1.61, and having a thickness from 0.1 mils to 1 mil;
   wherein the film is coextruded and biaxially oriented.
11. A film comprising, the following layers in the following order, with each layer being immediately adjacent to the next layer:
   a) a first (meth)acrylate layer comprising one or more polymers having a glass transition temperature, Tg, of 80° C. or lower;
   b) a first tie layer comprising a copolymer of polyethylene terephthalate, wherein the differences in refractive index between any two directions (x-y, x-z, or y-z) is less than 0.05, and having a thickness from 0.1 mils to 1 mil;
   c) a core layer comprising a homopolymer or copolymer of polyethylene terephthalate, wherein the difference in refractive index between the in-plane directions (x-y directions) is less than 0.05 and the difference between any in-plane direction and the out-of-plane direction (x-z and y-z directions) is greater than or equal to 0.10,
   d) a second tie layer comprising a copolymer of polyethylene terephthalate, wherein the differences in refractive index between any two directions (x-y, x-z, or y-z) is less than 0.05, and having a thickness from 0.1 mils to 1 mil;
   wherein the film is coextruded and biaxially oriented.
12. A film comprising, the following layers in the following order, with each layer being immediately adjacent to the next layer:
   a) a first (meth)acrylate layer comprising one or more polymers having a glass transition temperature, Tg, of 80° C. or lower;
   b) a first tie layer comprising a copolymer of polyethylene terephthalate, wherein the differences in refractive index between any two directions (x-y, x-z, or y-z) is less than 0.05, and having a thickness from 0.1 mils to 1 mil;
   c) a core layer comprising a homopolymer or copolymer of polyethylene terephthalate, wherein the difference in refractive index between the in-plane directions (x-y directions) is less than 0.05 and the difference between any in-plane direction and the out-of-plane direction (x-z and y-z directions) is from 0.10 to 0.25,
   d) a second tie layer comprising a copolymer of polyethylene terephthalate, wherein the differences in refractive index between any two directions (x-y, x-z, or y-z) is less than 0.05, and having a thickness from 0.1 mils to 1 mil;
   wherein the film is coextruded and biaxially oriented.
13. A film comprising, the following layers in the following order, with each layer being immediately adjacent to the next layer:
   a) a first (meth)acrylate layer comprising one or more polymers having a glass transition temperature, Tg, of 80° C. or lower;
   b) a first tie layer comprising a copolymer of polyethylene terephthalate having an elastic modulus of less than 1750 MPa and having a thickness from 0.1 mils to 1 mil;
   c) a core layer comprising a homopolymer or copolymer of polyethylene terephthalate having an elastic modulus of equal to or greater than 1750 MPa;
   d) a second tie layer comprising a copolymer of polyethylene terephthalate having an elastic modulus of less than 1750 MPa and having a thickness from 0.1 mils to 1 mil;

wherein the film is coextruded and biaxially oriented.
14. A film comprising, the following layers in the following order, with each layer being immediately adjacent to the next layer:
   a) a first (meth)acrylate layer comprising one or more polymers having a glass transition temperature, Tg, of 80° C. or lower;
   b) a first tie layer comprising a copolymer of polyethylene terephthalate having an elastic modulus of less than 2000 MPa and having a thickness from 0.1 mils to 1 mil;
   c) a core layer comprising a homopolymer or copolymer of polyethylene terephthalate having an elastic modulus of equal to or greater than 2000 MPa;
   d) a second tie layer comprising a copolymer of polyethylene terephthalate having an elastic modulus of less than 2000 MPa and having a thickness from 0.1 mils to 1 mil;
   wherein the film is coextruded and biaxially oriented.
15. A film according to any of the preceding embodiments, further comprising a second (meth)acrylate layer comprising one or more polymers having a glass transition temperature, Tg, of 80° C. or lower, immediately adjacent to the second tie layer.
16. A film according to any of the preceding embodiments, wherein the Tg of the second (meth)acrylate layer is from 60° C. to 80° C.
17. A film according to any of the preceding embodiments, wherein the Tg of the second (meth)acrylate layer is from 70° C. to 80° C.
18. A film according to any of the preceding embodiments, wherein the Tg of the second (meth)acrylate layer is from 70° C. to 74° C.
19. A film according to any of the preceding embodiments, wherein the Tg of the first (meth)acrylate layer is from 60° C. to 80° C.
20. A film according to any of the preceding embodiments, wherein the Tg of the first (meth)acrylate layer is from 70° C. to 80° C.
21. A film according to any of the preceding embodiments, wherein the Tg of the first (meth)acrylate layer is from 70° C. to 74° C.
22. A film according to any of the preceding embodiments, wherein the film, excluding any adhesive layers, has a delta H of at least 10 J/g.
23. A film according to any of the preceding embodiments, wherein the film, excluding any adhesive layers, has a delta H from 10 J/g to 50 J/g.
24. A film according to any of the preceding embodiments, wherein the first tie layer comprises a copolymer of polyethylene terephthalate having an average refractive index of 1.52 to 1.59.
25. A film according to any of the preceding embodiments, wherein the second tie layer comprises a copolymer of polyethylene terephthalate having an average refractive index of 1.52 to 1.59.
26. A film according to any of the preceding embodiments, wherein the first tie layer and the second tie layer, each, independently of each other, comprises a copolymer of polyethylene terephthalate having an average refractive index of 1.52 to 1.59.
27. A film according to any of the preceding embodiments, wherein the first tie layer comprises a copolymer of polyethylene terephthalate having an average refractive index of 1.56 to 1.57.
28. A film according to any of the preceding embodiments, wherein the second tie layer comprises a copolymer of polyethylene terephthalate having an average refractive index of 1.56 to 1.57.
29. A film according to any of the preceding embodiments, wherein the first tie layer and the second tie layer, each, independently of each other, comprises a copolymer of polyethylene terephthalate having an average refractive index of 1.56 to 1.57.
30. A film according to any of the preceding embodiments, wherein the core layer comprises a homopolymer or copolymer of polyethylene terephthalate having a refractive index in plane at least one direction (x or y, or both) from 1.63 to 1.67 and a refractive index out of plane (z direction) from 1.48 to 1.51.
31. A film according to any of the preceding embodiments, wherein the core layer comprises a homopolymer or copolymer of polyethylene terephthalate having a refractive index in plane at least one direction (x or y, or both) from 1.64 to 1.66 and a refractive index out of plane (z direction) from 1.48 to 1.50.
32. A film according to any of the preceding embodiments, wherein the core layer comprises a homopolymer or copolymer of polyethylene terephthalate having a refractive index in plane at least one direction (x or y, or both) of about 1.65 and a refractive index out of plane (z direction) of about 1.49.
33. A film according to any of the preceding embodiments, wherein the core layer comprises a homopolymer or copolymer of polyethylene terephthalate, wherein the difference in refractive index between the in-plane directions (x-y directions) is less than 0.05 and the difference between any in-plane direction and the out-of-plane direction (x-z and y-z directions) is from 0.12 to 0.20.
34. A film according to any of the preceding embodiments, wherein the core layer comprises a homopolymer or copolymer of polyethylene terephthalate, wherein the difference in refractive index between the in-plane directions (x-y directions) is less than 0.05 and the difference between any in-plane direction and the out-of-plane direction (x-z and y-z directions) is from 0.14 to 0.18.
35. A film according to any of the preceding embodiments, wherein the core layer comprises a homopolymer or copolymer of polyethylene terephthalate, wherein the difference in refractive index between the in-plane directions (x-y directions) is less than 0.05 and the difference between any in-plane direction and the out-of-plane direction (x-z and y-z directions) is from 0.15 to 0.17.
36. A film according to any of the preceding embodiments, wherein the core layer comprises a homopolymer or copolymer of polyethylene terephthalate, wherein the difference in refractive index between the in-plane directions (x-y directions) is less than 0.05 and the difference between any in-plane direction and the out-of-plane direction (x-z and y-z directions) is about 0.16.
37. A film according to any of the preceding embodiments, wherein the first tie layer and or the second tie layer, interpedently of each other, comprises a copolymer of polyethylene terephthalate, wherein the differences in refractive index between any two directions (x-y, x-z, or y-z) is less than 0.025.
38. A film according to any of the preceding embodiments, wherein the first tie layer and or the second tie layer, interpedently of each other, comprises a copolymer of polyethylene terephthalate, wherein the differences in refractive index between any two directions (x-y, x-z, or y-z) is less than 0.02.
39. A film according to any of the preceding embodiments, wherein the first tie layer and or the second tie layer, independently from each other, comprise a copolymer of polyethylene terephthalate having an elastic modulus of less than 1000 MPa.
40. A film according to any of the preceding embodiments, wherein the first tie layer and or the second tie layer, independently from each other, comprise a copolymer of polyethylene terephthalate having an elastic modulus of less than 1300 MPa.
41. A film according to any of the preceding embodiments, wherein the first tie layer and or the second tie layer, independently from each other, comprise a copolymer of polyethylene terephthalate having an elastic modulus of less than 1500 MPa.
42. A film according to any of the preceding embodiments, wherein the first tie layer and or the second tie layer, independently from each other, comprise a copolymer of polyethylene terephthalate having an elastic modulus of less than 1750 MPa.
43. A film according to any of the preceding embodiments, wherein the first tie layer and or the second tie layer, independently from each other, comprise a copolymer of polyethylene terephthalate having an elastic modulus of less than 2000 MPa.
44. A film according to any of the preceding embodiments, wherein the core layer comprises a homopolymer or copolymer of polyethylene terephthalate having an elastic modulus of equal to or greater than 2000 MPa.
45. A film according to any of the preceding embodiments, wherein the core layer comprises a homopolymer or copolymer of polyethylene terephthalate having an elastic modulus of equal to or greater than 2500 MPa.
46. A film according to any of the preceding embodiments, wherein the core layer comprises a homopolymer or copolymer of polyethylene terephthalate having an elastic modulus of equal to or greater than 3000 MPa.
47. A film according to any of the preceding embodiments, wherein the first tie layer and the second tie layer each has a thickness, independently from each other, from 0.1 mils to 1 mil.
48. A film according to any of the preceding embodiments, wherein the first tie layer and the second tie layer each has a thickness, independently from each other, from 0.1 mils to 0.5 mils.
49. A film according to any of the preceding embodiments, wherein the first (meth)acrylate layer and the second (meth)acrylate layer each has a thickness, independently from each other, from 0.2 mils to 1 mil and the film has a width of 36 inches or more.
50. A film according to any of the preceding embodiments, wherein the first (meth)acrylate layer and the second (meth)acrylate layer each has a thickness, independently from each other, from 0.2 mils to 1 mil and the film has a width from 36 inches to 60 inches.
51. A film according to any of the preceding embodiments, wherein the first (meth)acrylate layer and the second (meth)acrylate layer each has a thickness, independently from each other, from 0.2 mils to 1 mil and the film has a width from 48 inches to 52 inches.
52. A film according to any of the preceding embodiments, wherein the core layer has a thickness from 0.5 mils to 5 mils.
53. A film according to any of the preceding embodiments, wherein the core layer has a thickness from 0.75 mils to 3 mils.
54. A film according to any of the preceding embodiments, wherein the core layer has a thickness from 1 mils to 2 mils.
55. A film according to any of the preceding embodiments, wherein the stretch ratio of the biaxially oriented film in the machine direction is from 1.2 to 4.
56. A film according to any of the preceding embodiments, wherein the stretch ratio of the biaxially oriented film in the machine direction is from 2 to 4.
57. A film according to any of the preceding embodiments, wherein the stretch ratio of the biaxially oriented film in the machine direction is from 2.5 to 3.8.
58. A film according to any of the preceding embodiments, wherein the stretch ratio of the biaxially oriented film in the transverse direction is from 1 to 6.
59. A film according to any of the preceding embodiments, wherein the stretch ratio of the biaxially oriented film in the transverse direction is from 2.5 to 5.
60. A film according to any of the preceding embodiments, wherein the stretch ratio of the biaxially oriented film in the transverse direction is from 3.5 to 4.5.
61. A film according to any of the preceding embodiments, wherein the first (meth)acrylate layer and the second (meth)acrylate layer each comprises, independently from each other, one or more of the following comonomers: ethyl-acrylate and butyl-acrylate.
62. A film according to any of the preceding embodiments, wherein the copolymer of polyethylene terephthalate in the first tie layer and/or the second tie layer each comprises, independently from each other, a reaction product of one or more polyol comonomer and one or more dicarboxylic acid comonomers, wherein the polyol comonomers are chosen from polyols having branched C4-C10 alkyl units and polyols having cyclic C4-C10 alkyl units and the dicarboxylic acid comonomer comprises terephthalate and/or naphthalate subunits.
63. A film according to any of the preceding embodiments, wherein the copolymer of polyethylene terephthalate in the first tie layer and/or the second tie layer each comprises, independently from each other, a reaction product of one or more polyol comonomer and one or more dicarboxylic acid comonomer, wherein the polyol comonomers are chosen from ethylene glycol, neopentyl glycol, and cyclohexane dimethanol and the dicarboxylic acid comonomers are chosen from isophthalate, sodiumsulfoisophthalate, naphthalate, and terephthalate subunits.
64. A film according to any of the preceding embodiments, wherein the polymer of the core layer comprises carboxylate comonomer units and glycol comonomer units.
65. A film according to any of the preceding embodiments, wherein the polymer of the core layer comprises carboxylate comonomer units chosen from terephthalic acid; isophthalic acid; 2,6-naphthalene dicarboxylic acid and isomers thereof and glycol comonomer units chosen from ethylene glycol; propylene glycol; 1,4-butanediol and isomers thereof; 1,6-hexanediol; neopentyl glycol; diethylene glycol; tricyclodecanediol; 1,4-cyclohexanedimethanol and isomers thereof.
66. A film according to any of the preceding embodiments, wherein the polymer of the core layer is polyethylene terephthalate homopolymer.
67. A film according to any of the preceding embodiments, wherein the first (meth)acrylate layer and the second (meth)acrylate layer each comprises, independently from each other, one or more UV absorbers.
68. A film according to any of the preceding embodiments, wherein the first (meth)acrylate layer and the second (meth)acrylate layer each comprises, independently from each other, one or more hindered amine light stabilizers.
69. A film according to any of the preceding embodiments, wherein the first (meth)acrylate layer and the second (meth)acrylate layer each comprises, independently from each other, one or more impact modifiers.
70. A film according to any of the preceding embodiments, wherein the first (meth)acrylate layer, the second (meth)acrylate layer, or both comprise(s), independently from each other, one or more impact modifiers, wherein the impact modifier is chosen from 2-layer and 3 layer shells and the loading (w/w) is chosen from a 18% to 60%, 20% to 60%, 25% to 60%, 25% to 55%, 25% to 50%, 25% to 40%, 25% to 30%, 30% to 60%, 30% to 55%, 30% to 50%, and 30% to 40%.
71. A film according to any of the preceding embodiments, wherein the first (meth)acrylate layer, the second (meth)acrylate layer, or both comprise(s), independently from each other, an ABA block copolymer with polymethylmethacrylate (PMMA) end blocks and a poly (n-butyl acrylate) (PnBA) mid-block.
72. A film according to any of the preceding embodiments, wherein the first (meth)acrylate layer, the second (meth)acrylate layer, or both comprise(s), independently from each other, an ABA block copolymer with polymethylmethacrylate (PMMA) end blocks and a poly (n-butyl acrylate) (PnBA) mid-block, wherein the concentration (w/w) of the ABA block copolymer is chosen from 1% to 25%, from 1% to 20%, from 1% to 15%, from 1% to 13%, from 1% to 10%, 3% to 25%, from 3% to 20%, 3% to 15%, from 3% to 13%, from 3% to 10%, from 5% to 25%, from 5% to 20%, 5% to 15%, from 5% to 13%, from 5% to 10%, from 10% to 25%, from 10% to 20%, 10% to 15%, from 10% to 13%, from 15% to 25%, and from 15% to 20%.
73. A film according to any of the preceding embodiments, wherein the first (meth)acrylate layer, the second (meth)acrylate layer, or both comprise(s), independently from each other, an ABA block copolymer with polymethylmethacrylate (PMMA) end blocks and a poly (n-butyl acrylate) (PnBA) mid-block, wherein neither the first (meth)acrylate layer nor the second (meth)acrylate layer comprise impact modifiers.
74. A film according to any of the preceding embodiments, wherein the first (meth)acrylate layer, the second (meth)acrylate layer, or both comprise(s), independently from each other, an ABA block copolymer with polymethylmethacrylate (PMMA) end blocks and a poly (n-butyl acrylate) (PnBA) mid-block, wherein the first (meth)acrylate layer and the second (meth)acrylate layer, independently from each other, comprise impact modifiers at a loading (w/w) chosen from 18% to 60%, 20% to 60%, 25% to 60%, 25% to 55%, 25% to 50%, 25% to 40%, 25% to 30%, 30% to 60%, 30% to 55%, 30% to 50%, 30% to 40%, 20%, 30%, 40%, 50%, and 55%.
75. A film according to embodiment 74, wherein the loading of the ABA block copolymer is chosen from 1% to 25%, from 1% to 20%, from 1% to 15%, from 1% to 13%, from 1% to 10%, 3% to 25%, from 3% to 20%, 3% to 15%, from 3% to 13%, from 3% to 10%, from 5% to 25%, from 5% to 20%, 5% to 15%, from 5% to 13%, from 5% to 10%, from 10% to 25%, from 10% to 20%, 10% to 15%, from 10% to 13%, from 15% to 25%, and from 15% to 20%.
76. A film according to any of the preceding embodiments, wherein the Rq of the surface of the outermost (meth)acrylate layer is chosen from higher than 0.4 nm, from 0.4 nm to 0.7 nm, from 0.4 nm to 0.65 nm, and from 0.4 nm to 0.6 nm.
77. A film according to any of the preceding embodiments, wherein the Ra of the surface of the outermost (meth)acrylate is chosen from higher than 0.3 nm, from 0.3 nm to 0.6 nm, from 0.3 nm to 0.55 nm, from 0.3 nm to 0.5 nm, from 0.3 nm to 0.45 nm, from 0.35 nm to 0.6 nm, from 0.35 nm to 0.55 nm, from 0.35 nm to 0.5 nm, and from 0.35 nm to 0.45 nm.
78. A film according to any of the preceding embodiments, wherein, independently from each other, the Rq of the surface of the outermost (meth)acrylate is chosen from higher than 0.4 nm, from 0.4 nm to 0.7 nm, from 0.4 nm to 0.65 nm, and from 0.4 nm to 0.6 nm and the Ra of the surface of the outermost (meth)acrylate is chosen from higher than 0.3 nm, from 0.3 nm to 0.6 nm, from 0.3 nm to 0.55 nm, from 0.3 nm to 0.5 nm, from 0.3 nm to 0.45 nm, from 0.35 nm to 0.6 nm, from 0.35 nm to 0.55 nm, from 0.35 nm to 0.5 nm, and from 0.35 nm to 0.45 nm.
79. A film according to any of the preceding embodiments, wherein the first (meth)acrylate layer and/or the second (meth)acrylate layer each comprises, independently from each other, one or more compounds chosen from UV absorbers, hindered amine light stabilizers, and impact modifiers (with loadings described in embodiments above).
80. A film according to any of the preceding embodiments, wherein the first tie layer and/or the second tie layer each comprises, independently from each other, one or more compounds chosen from UV absorbers, hindered amine light stabilizers, and impact modifiers (with loadings described in embodiments above).
81. A film according to any of the preceding embodiments, wherein the core layer comprises one or more compounds chosen from UV absorbers, hindered amine light stabilizers, and impact modifiers (with loadings described in embodiments above).
82. A film according to any of the preceding embodiments, wherein the core layer comprises one or more fluorescent compounds.
83. A film according to any of the preceding embodiments, wherein any one of the first and second tie layers, the core layer, and the first and second (meth)acrylate layers, independently from each other, comprises one or more fluorescent compounds.
84. A film according to any of the preceding embodiments, wherein any one of the first and second tie layers, the core layer, and the first and second (meth)acrylate layers, independently from each other, comprises one or more fluorescent compounds chosen from solvent yellow SY98 and solvent orange SO63.
85. A film according to any of the preceding embodiments, wherein the film is transparent.
86. A film according to any of the preceding embodiments, further comprising an adhesive layer adjacent the second tie layer.
87. An overlay film comprising a film according to any of the preceding embodiments.
88. A retroreflective film comprising a film according to any of the preceding embodiments.
89. A retroreflective film comprising a film according to any of the preceding embodiments comprising a prismatic layer.
90. A retroreflective film comprising a film according to any of the preceding embodiments comprising a prismatic layer comprising a polycarbonate.
91. A retroreflective film comprising a film according to any of the preceding embodiments, comprising a prismatic layer comprising a cured acrylic component.
92. A retroreflective film comprising a film according to any of the preceding embodiments comprising a beaded layer.
93. A retroreflective article comprising a film according to any of the preceding embodiments.
94. A film according to any of the preceding embodiments, further comprising a printed layer immediately adjacent the first (meth)acrylate layer.
95. A film according to any of the preceding embodiments, further comprising a printed layer immediately adjacent the first (meth)acrylate layer and immediately adjacent the first tie layer.
96. A film according to any of the preceding embodiments, further comprising a printed layer immediately adjacent the first (meth)acrylate layer, wherein the printed layer is a discontinuous layer.

### EXAMPLES

The following examples describe some exemplary constructions of various embodiments of the retroreflective articles and methods of making the retroreflective articles described in the present application. The following examples describe some exemplary constructions and methods of constructing various embodiments within the scope of the present application. The following examples are intended to be illustrative, but are not intended to limit the scope of the present application.

Unless otherwise noted or readily apparent from the context, all parts, percentages, ratios, etc. in the Examples and the rest of the specification are by weight.

### Materials Used in the Examples

| Abbreviation | Description and Source |
|---|---|
| GN071 | A copolyester from Eastman (Kingsport, TN) available under the trade |
| | name Eastar Copolyester GN071 |
| PET 1N404 | A 0.64 IV PET polyester from NanYa Plastics, Lake City, S.C. |
| NanYa 1N502 | A 0.67 IV PET polyester from NanYa Plastics, Lake City, S.C. |
| 8020 or | A copolyester from 3M Corp, Maplewood, MN, comprised of |
| 8020CoPET | terepthahlaitc and isopthalic moieties in an 8020 molar ratio |
| Kraton G1645 | An SEBS block copolymer from Kraton Corporation, Houston, TX |
| PRD 510A, | A CoPMMA available from Arkema Industries, Philadelphia, PA |
| ATOGLAS 510A | |
| PMMA CA-24 | Optix CA-24 a CoPMMA available from Plaskolite Industries Columbus, |
| | OH |
| Tinuvin 1600 | A triazine UVA available from BASF Corporation, Florham Park, NJ |
| LA2250 | ABA block copolymer with polymethylmethacrylate end blocks and a |
| | poly(n-butyl acrylate) mid-block from Kurarity, Tokyo, Japan |
| IM MOD | CoPMMA with acrylic impact modifier particles which often have a |
| CoPMMA | PMMA shell and a crosslinked poly (n-butyl acrylate) core. [Plaskolite] |
| TSS #4 | IM MOD CoPMMA with 20% 3 layer acrylic impact modifier particles: |
| | experimental material made by Plaskolite for 3M |
| TSS #5 | IM MOD CoPMMA with 20% 3 layer acrylic impact modifier particles: |
| | experimental material made by Plaskolite for 3M |
| TSS #10 | IM MOD CoPMMA with 50% 2 layer acrylic impact modifier particles: |
| | experimental material made by Plaskolite for 3M |
| TSS #20 | IM MOD CoPMMA with 40% 2 layer acrylic impact modifier particles |
| | and UVA: experimental material made by Plaskolite for 3M |
| TSS #21 | IM MOD CoPMMA with 30% 2 layer acrylic impact modifier particles |
| | and UVA: experimental material made by Plaskolite for 3M |

### Preparation of Examples

Examples were prepared for some embodiments of the invention including a 4-layer film construction and a 5-layer film construction. The constructions include coextruded, biaxially oriented CoPMMA, PET and amorphous PET (i.e. PETG or 80/20 blend of DMT/DMI) followed by annealing at a heat set temperature in some cases. The process conditions of the coextrusion and biaxial orientation were such that the constructions have a crystalline PET core and amorphous PET skin adjacent one side of the crystalline PET core or a crystalline PET core sandwiched by amorphous PET skins. The crystalline character of the base film provides the dimensional stability required for using the film without a separate film carrier.

### 4-Layer Examples

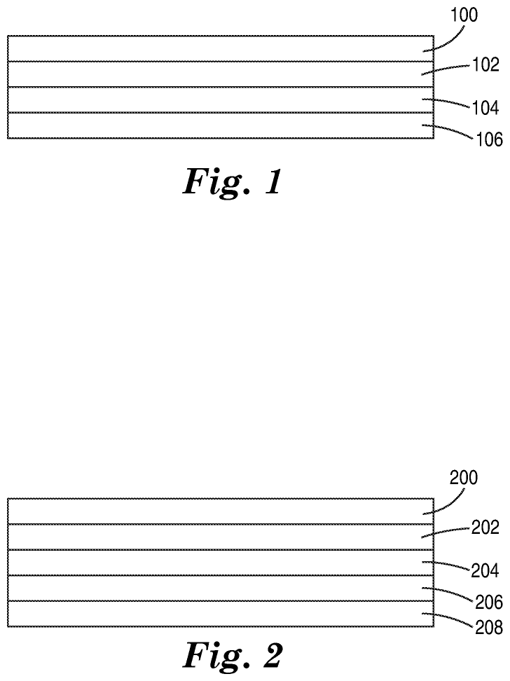

The 4-layer construction shown in FIG. 1 may be referred to as an ABAC film construction where 102 and 106 are A layers including an amorphous skin layer, 104 is a B layer including a core layer, and 100 is an C layer including an acrylic layer. Tables 1 and 2 show exemplary constructions of 4-layer films.

TABLE 1
Co-extruded, biaxially oriented 4-layer film constructions

| | C Layer | A Layer | B Layer | A Layer |
|---|---|---|---|---|
| Examples | (100) | (102) | (104) | (106) |
| A319129-019 | CoPMMA: CA24 (w/Tin | GN071 | PET | GN071 |
| | 1600) | | 1N404 | |
| A319130-002 | CoPMMA: CA24 (w/Tin | GN071 | PET | GN071 |
| | 1600) | | 1N404 | |
| A319130-007 | CoPMMA: CA24 (w/Tin | GN071 | PET | GN071 |
| | 1600) | | 1N404 | |
| A319130-008 | CoPMMA: CA24(w/Tin | GN071 | PET | GN071 |
| | 1600) | | 1N404 | |
| A319130-013 | IM MOD PMMA: TSS #20 | GN071 | PET | GN071 |
| | (w/Tin 1600) | | 1N404 | |
| A319131-003 | IM MOD PMMA: TSS #21 | GN071 | PET | GN071 |
| | (w/Tin 1600) | | 1N404 | |
| A319131-005 | IM MOD PMMA: TSS #21 | GN071 | PET | GN071 |
| | (w/Tin 1600) | | 1N404 | |

Utilizing the layer construction depicted in FIG. 1, films in Table 1 with ABAC layer construction were produced as follows:

The A layers were fed using a 40 mm twin-screw extruder which was run under vacuum and utilized a progressive temperature profile with an 8/0 temp of 520 F. The associated gear pump and neck tube also were heated to 520 F. The B layer was fed using a 50 m twin-screw extruder which was run under vacuum and utilized a progressive temperature profile with an 8/0 temp of 520 F. The associated gear pump and neck tube also were heated to 520 F. The C layer was fed using a 40 mm twin-screw extruder which was run under vacuum and utilized a progressive temperature profile with an 8/0 temp of 520 F. The associated gear pump and neck tube also were heated to 520 F. The 4-layer feed block was heated to 520 F. The die was positioned just above a rotating 80 F chill roll with associated electrostatic pinning for rapid web quenching. Films were produced on this equipment with cast web thicknesses of about 30 mils. These cast webs were then conveyed through a conventional length orienter using a stretch ratio of about 333% with an oven temperature of 160 F with associated IR panels. Films were then conveyed through a conventional tenter and stretch to about 350% with an oven temperature of 200-210 F. These films were then conveyed through an annealing zone with an oven with a temperature of 455 F.

TABLE 2
Co-extruded, biaxially oriented 4-Layer film constructions anc extruder conditions

| | | Feeder | Feeder | A Layer | Feeder | B Layer | Feeder |
|---|---|---|---|---|---|---|---|
| Examples | C Layer (100) | Ib/h | Ib/h | (102, (106) | lbs/h | (104) | lbs/h |
| 15-09935-1A | coPMMA 510A/TinUVIN 1600 | 9.6 | 0.4 | GN071 | 10 | PET 1N404 | 20 |
| 15-09935-8A | coPMMA 510A/Tin 1600 | 9.6 | 0.4 | 8020 CoPET | 10 | PET 1N404 | 20 |
| 15-09935-15A | CA-24/Tin 1600 | 9.6 | 0.4 | GN071 | 10 | PET 1N404 | 20 |
| 15-09935-17A | TSS #4/Tin 1600 | 9.6 | 0.4 | GN071 | 10 | PET 1N404 | 20 |
| 15-09935-18A | TSS #5/Tin 1600 | 9.6 | 0.4 | GN071 | 10 | PET 1N404 | 20 |
| 15-09935-20A | TSS #10/Tin 1600 | 9.6 | 0.4 | GN071 | 10 | PET 1N404 | 20 |
| 15-09935-24A | 90% 510A/10% LA 2250/Tin 1600 | 9.6 | 0.4 | PETG | 10 | PET 1N404 | 20 |
| 16-11034-1 | PMMA CA24/TINUVIN 1600 | 4.8 | 0.2 | PET 1N404 | 4 | PET 1N404 | 24 |
| 16-11034-2 | PMMA CA24/TINUVIN 1600 | 5.56 | 0.23 | GN071 | 5 | PET 1N404 | 28.5 |
| 16-11034-3 | PMMA CA24/TINUVIN 1600 | 11.14 | 0.46 | GN071 | 5 | PET 1N404 | 21.7 |
| 16-11034-14 | PMMA CA24/TINUVIN 1600 | 5.56 | 0.23 | 8020 CoPET | 5 | PET 1N404 | 28.5 |
| 16-11034-15 | PMMA CA24/TINUVIN 1600 | 11.14 | 0.46 | 8020 CoPET | 5 | PET 1N404 | 21.7 |

Utilizing the layer construction depicted in FIG. 1, films in Table 2 with ABAC layer construction were produced as follows.

The core/tie layers (or “A” layers) were produced by extruding the above-identified resins using a 25 mm Twin-Screw Extruder (TSE), conveyed via a neck tube using a gear pump, and fed into the first and third layers of a 4-layer ABAC feed block. This melt train used a progressive temperature extrusion profile, with a peak temperature of 260-270° C. The 2^{nd} layers (or “B” layer) was produced by extruding the above identified resins using a 27 mm TSE with a progressive temperature profile peaking at about 270-280° C., conveyed via a neck tube using a gear pump, and fed into the 2^{nd} of the 4-layer feed block. The top layer (or “C” layer) was produced by extruding CoPMMA and UVA materials using a 27 mm TSE with a progressive temperature profile peaking at about 260° C., conveyed via a neck tube using a gear pump, and fed to the top layer of the 4-layer feed block. The feed block and 20.3 cm (8 inch) film die were each maintained at a target temperature of 270° C. while the film casting wheel was maintained at about 25° C. Film cast webs of 15 and 30 mils thickness were produced by this process. The cast webs were then place into a KARO batch orientation device and conveyed into a 95 C oven where they were held for 60 sec, and then were biaxially elongated by 300% in both the downweb and crossweb directions. These films were then conveyed onto a second oven where they were held for 15 seconds at 225 C.

### 5-Layer Examples

The 5-layer construction shown in FIG. 2 may be referred to an ABCBA film construction where 202 and 206 are B layers including an amorphous skin layer, 204 is a C layer including a core layer, and 200 and 208 are A layers including an acrylic layer. Table 3 show exemplary constructions of 4-layer films.

TABLE 3
Top film constructions with a semi-crystalline core layer (Layer C) sandwiched by two
amorphous skin layers (Layer B) and acrylic layers (Layer A) adjacent the amorphous skin layers
with extruder feed rates.

| | | | | | | 25 mm T.S. | |
|---|---|---|---|---|---|---|---|
| | | | | L-2 27 mm | | Core (A Layers) | |
| | L-2 27 mm T.S. (C Layer) | | | T.S. (B Layer) | | | KT-1 |
| | | Feeder 1-1 | Feeder 1-2 | | Feeder 1-1 | | Feeder |
| Description | Resin | Lbs/Hr | Lbs/Hr | Resin | Lbs/Hr | Resin | LBs/Hr |
| 13-0-7033-1 | PRD 510A/ | 9.8 | 0.2 | GN071 | 10 | NANYA IN502 | 20 |
| | TINUVIN 1600 | | | | | | |
| 13-07033-3 | PRD 510A/ | 9.8 | 0.2 | 80/20 | 10 | NANYA IN502 | 20 |
| | TINUVIN 1600 | | | Co PET | | | |
| 13-07033-6 | PRD 510A/ | 9.8 | 0.2 | Kraton | 10 | NANYA IN502 | 20 |
| | TINUVIN 1600 | | | 1645 | | | |
| 13-07033-7 | PRD 510A/ | 9.6 | 0.4 | GN071 | 10 | NANYA IN502 | 20 |
| | TINUVIN 1600 | | | | | | |

Utilizing the layer construction depicted in FIG. 2, films in Table 2 with ABCBA layer construction were produced as follows:

The outer layers (or skin layers, or “A” layers) were produced by extruding the above-identified resins using a 27 mm Twin-Screw Extruder (TSE), conveyed via a neck tube using a gear pump, and fed into the 2 outer layers of a 5-layer feed block. This melt train used a progressive temperature extrusion profile, with a peak temperature of 260-270° C. The 2^{nd} and 4th layers (or tie layers, or “B” layers) were produced by extruding the above identified resins using a 27 mm TSE with a progressive temperature profile peaking at about 240-260° C., conveyed via a neck tube using a gear pump, and fed into the 2^{nd} and 4^{th} layers of a 5-layer feed block. The inner layer (or core layer, or “C” layer) was produced by extruding PET resin using a 25 mm TSE with a progressive temperature profile peaking at about 270° C., conveyed via a neck tube using a gear pump, and fed into the middle layer of a 5-layer feed block. The feed block and 20.3 cm (8 inch) film die were each maintained at a target temperature of 270° C. while the film casting wheel was maintained at about 25° C. Film cast webs of 15 and 30 mils thickness were produced by this process. The cast webs were then place into a KARO batch orientation device and conveyed into a 95 C oven where they were held for 60 sec, and then were biaxially elongated by 300% in both the downweb and crossweb directions. These films were then conveyed onto a second oven where they were held for 15 seconds at 225 C.

### Test Methods

### Test Method 1: Top Wave Measurements

The TopWave ML2000 Layer Gauge (TopWave Industries Inc., Marietta Ga.) was used to conduct non-destructive optical interferometry utilizing constructive interference from layer interfaces with differing refractive indices. Actual thickness is calculated using the following formula: Absolute thickness=Optical Thickness/Refractive Index

### Test Method 2: DSC Measurements

Approximately 5-10 mg of each of the polymer or film samples were placed in individual standard aluminum differential scanning calorimeter (DSC) pans (obtained as part no. T080715, from TA Instruments, New Castle, Del.) and placed in the autosampler of a differential scanning calorimeter (DSC) (obtained under the trade designation “MODEL Q2000” from TA Instruments. For each sample analysis, pans were individually placed on one of the differential posts in the DSC's enclosed cell along with an empty reference pan on the opposite post. Temperature was driven to 20° C. and held for 3 minutes and then increased to 300 C at a rate of 10 C per minute. Transitions such as the melting temperature (Tm) and glass transition temperature (Tg) were identified as their respective peaks in the scanning profile of heat flow vs. temperature. Typically melting transitions show up as heat flow peaks as the sample is heated. A glass transition is generally represented by a shift in the profile upon heating where the heat profile after the transition is parallel but shifted lower compared to before the transition. The glass transition temperature is recorded at the inflection point of the curve associated with this shift in heat flow profile.

### Test Method 3: Modulus Measurements

Layer thickness and elastic modulus measurements of cross-sections of the film were done using Atomic Force Microscopy (AFM). Films were cut into 3 by 5 mm rectangular samples and mounted into a metal vice exposing the film edge to be analyzed. The sample edge was microtomed with a Leica UC7 Ultramicrotome using a Diatome diamond edge knife providing fairly flat and smooth cross-sections, exposing all the layers in the sheeting. A Bruker Icon AFM with Peak Force Quantitative Nano Mechanical Technology (PF QNM) was used for imaging the layers. The force curves in PF QNM were generated at 2K Hertz keeping the tip in the vertical direction. The Elastic Modulus was obtained using the Derjaguin-Muller-Toporov (DMT) model. Image processing and data analysis were done with the accompanying software. The images were analyzed using the section feature of the software that allows for a single line of data or a rotation box that allows for multiple lines of data to be averaged in the y direction of the image. The elastic modulus data was obtained using the rotating box feature of the section analysis in the DMT modulus image. In some embodiments, thickness was determined based on both the height and DMT modulus images. The thickness is reported in microns (μm) and modulus in MPa.

### Test Method 4: Peel Force Measurements

A peel force approximately 90 degrees from the major surface of each sample was measured after delamination was manually initiated using 3M Scotch 893 tape adhered to the major surfaces of each sample. Samples for the peel test where prepared in 1-inch strips. Each sample strip was adhered on a rigid flat glass plate as part of a fixture for an Imass Slip-Peel Tester SP-2000 (IMASS, Inc., Acord, Mass.). The 3M Scotch 893 adhered to the sample strip was attached to the slip-peel tester and a peel force was measured as an average force over the travel distance of the peel along the machine direction of the film (down web direction) and at a slide speed of 60 inches per minute.

### Test Method 5: AFM Surface Roughness Measurements

### Surface Roughness Measurement Method

Atomic Force Microscopy (AFM) is an imaging technique that consists of a flexible cantilever with a sharp tip attached to the cantilever's free end. AFM makes use of the forces of interaction between the tip and sample which cause the cantilever to deflect as it scans across the surface. At each x-y position, the cantilever deflection is measured via a laser beam reflected off the cantilever's backside and detected by a photodiode. The z(x,y) data is used to construct a three-dimensional topography map of the surface. In Tapping Mode AFM, the tip/cantilever assembly is oscillated at the resonant frequency of the cantilever; the amplitude of vertical oscillation is the input parameter for the feedback loop. In a topographic AFM image, “brighter regions” correspond to peaks while “darker regions” correspond to valleys.

Tapping Mode AFM was performed using Bruker's Dimension ICON with a Nanoscope 8.15 software and a Nanoscope V Controller. An OTESPA-R3 tip (nominal resonant frequency of 300 kHz, Spring Constant of 26 N/m and tip radius of 7 nm) was used. The tapping setpoint was typically 90% of the free air amplitude. All AFM experiments were performed under ambient conditions. An offline data processing software, Nanoscope Analysis, was used for image processing and analysis. When necessary, images were applied with 0th order flatten (to remove z-offsets or horizontal skip artifacts) or a first order planefit (to remove sample tilt). Average surface roughness (i.e. Ra) and root mean square roughness (i.e. Rq) calculations were performed on tilt-corrected/0th order flattened topographical images. The Ra is the arithmetic average of the absolute values of the surface height deviations measured from the mean plane. The Rq or RMS is the root mean square average of height deviations taken from the mean data plane.

Samples A319131-013 and A319131-005 show impact modifier particles in the three-dimensional topography map of the surface. Table x. shows the average surface roughness and root mean square surface roughness for 3 different line profiles for 3 samples and the average and standard deviation of the Ra and Rq for the 3 line profiles of each sample.

### Examples—Results

### Test Method 1 Results:

Results from Top Wave measurements showing thicknesses for the different layers are in Table 4.

TABLE 4
Top wave thickness measurements of examples. The PMMA
layer (C Layer - 100), PETg (A Layer 102), PET (B
Layer - 104), and PETg (column 5, A Layer 106). The
6th column shows the total thickness of each example.

| | PMMA | PETg | PET | PETg | Total |
|---|---|---|---|---|---|
| Examples | (μm) | (μm) | (μm) | (μm) | (μm) |
| A319129-019 | 12.2 | 4.6 | 57.2 | 4.3 | 78.3 |
| A319130-002 | 11.6 | 4.1 | 27.8 | 3.6 | 47.1 |
| A319130-007 | 15.2 | 2.7 | 26.5 | 2.1 | 46.5 |
| A319130-013 | 15.3 | 2.6 | 33.4 | 2.9 | 54.2 |
| A319131-003 | 19.1 | 3.2 | 29.8 | 2.6 | 54.7 |
| A319131-005 | 36.4 | 4.9 | 43.2 | 3.3 | 87.8 |

In the multilayer construction, the PET core layer is the thickest layer necessary for dimensional stability of the film. The amorphous PET tie layers are the thinnest, typically, less than 6 microns in thickness to provide interlayer adhesion within the film and adhesion of the film to the microreplication cubes in the retroreflective sheeting. The Co-PMMA skin layer thickness ranges from 10 to 20 microns needed for outdoor durability of the construction.

### Test Method 2 Results: DSC Measurements

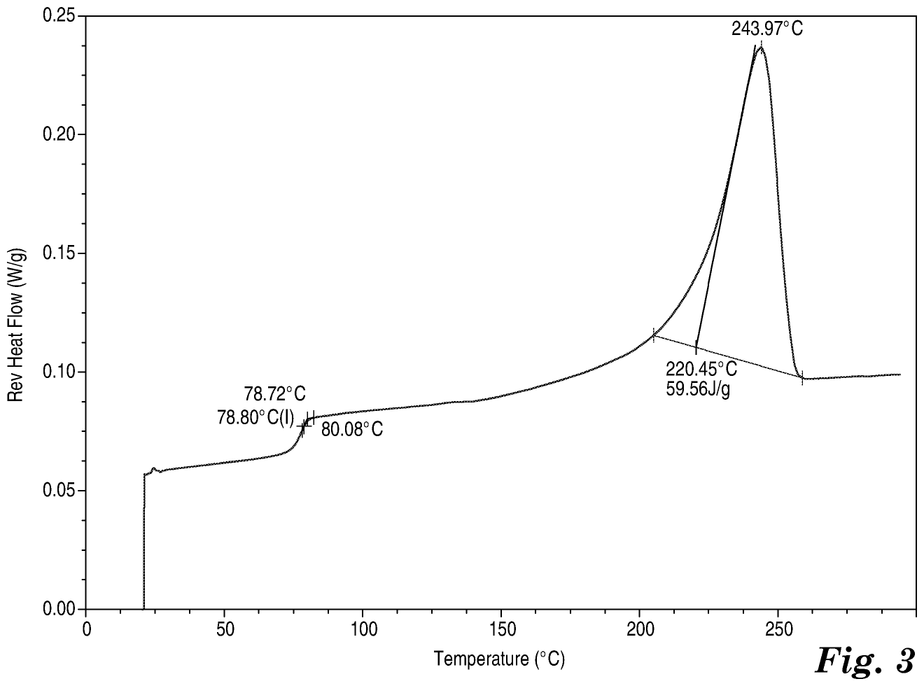

FIGS. 3 to 9 show DSC scans for different samples. FIG. 3 shows a DSC scan of a comparative PET polyester with a distinct melt point around 250 C and distinct Tg around 80 C for this semi-crystalline polymer.

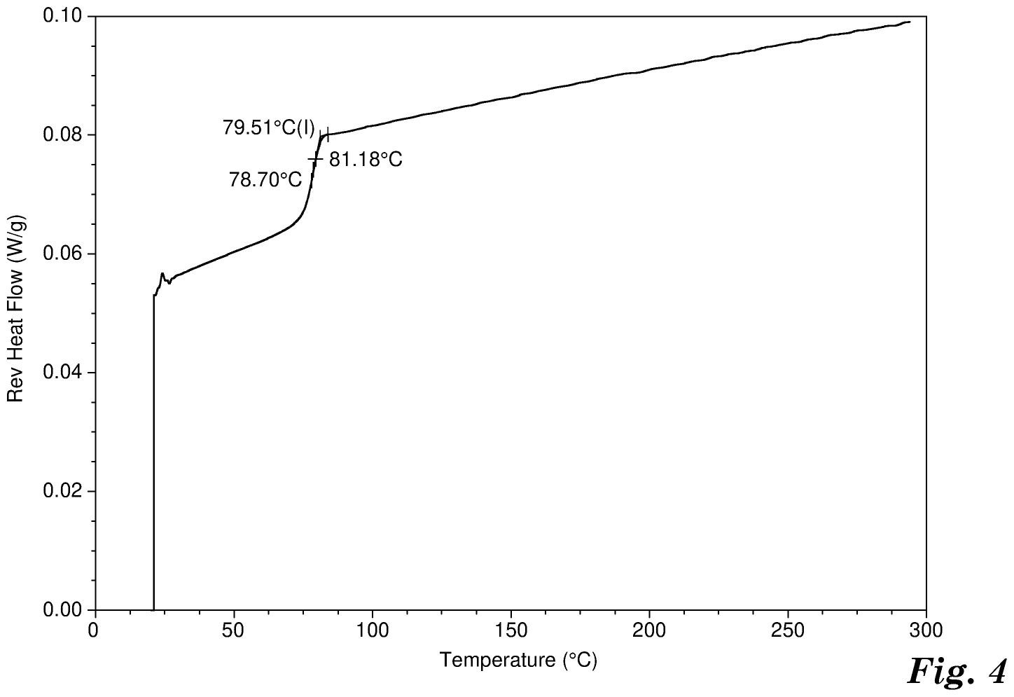

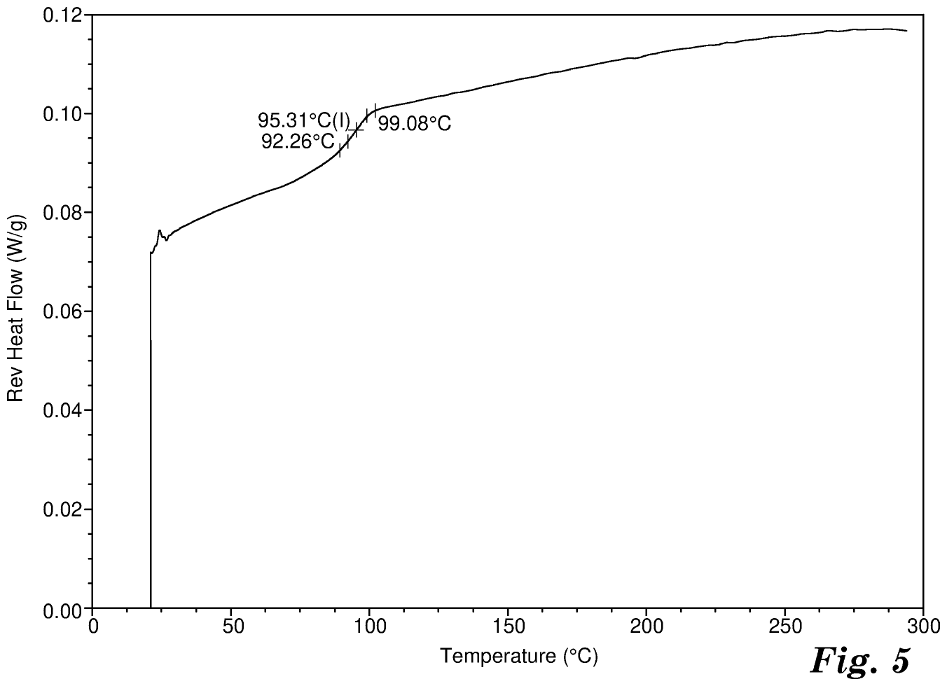

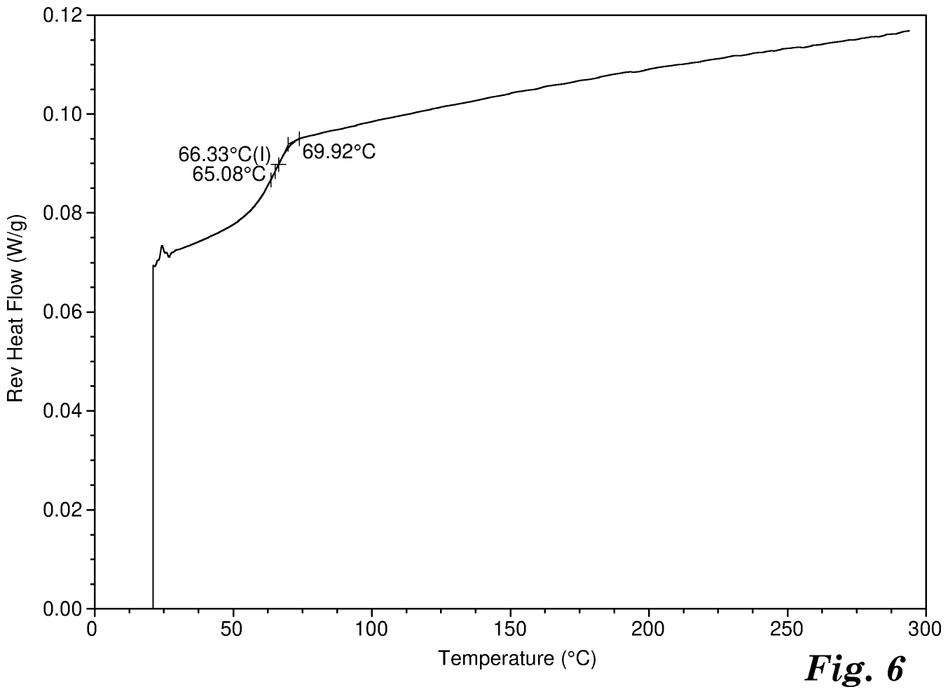

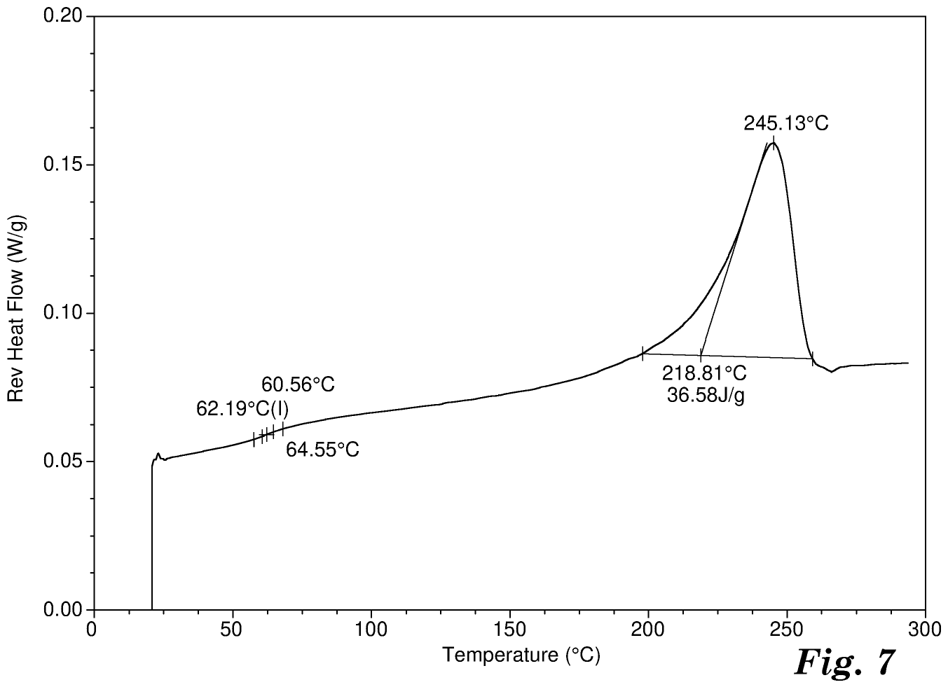

FIG. 4 shows a DSC scan of a comparative amorphous co-polyester. As can be seen in the scan, there is no distinct melt point, but there is a distinct Tg around 80 C. FIG. 5 shows a DSC scan of a comparative PMMA polymer which we use for extrusion and/or co-extrusion with some films. The scan shows there is no melt point but there is a distinct Tg at ˜95 C for this amorphous material. FIG. 6 shows a DSC scan of a comparative CoPMMA polymer which is used for extrusion and co-extrusion with some films. The scan shows there is no melt point but there is a distinct Tg at ˜70 C for this amorphous material. FIG. 7 shows a DSC scan of a 4 layered construction (PETg/PET/PETg/CoPMMA) (Example A319130-002). In this case, there is a distinct melt point from the PET. The Tg is a bit smeared as the materials involved here exhibit Tg's in distinct, but nearby locations which effectively diminishes the ability to clearly see the Tg.

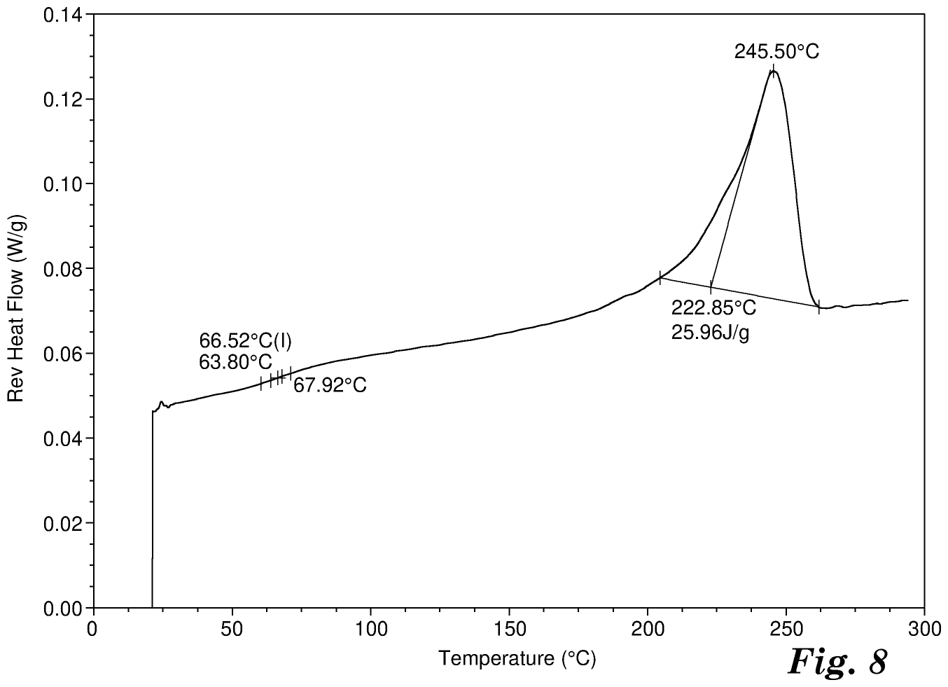

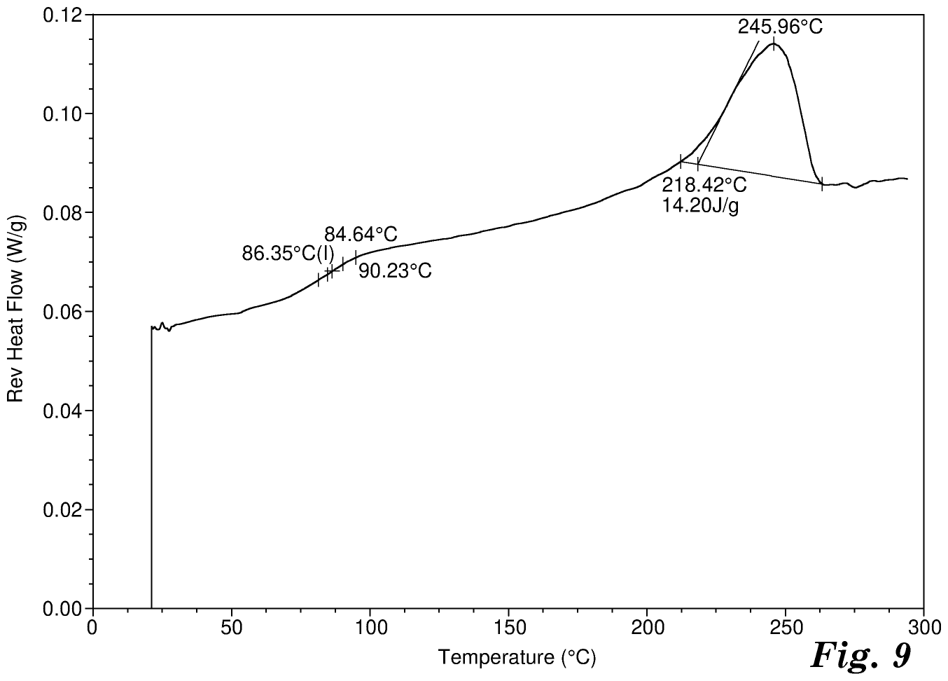

FIG. 8 is a DSC scan of a 4-layered construction (PETg/PET/PETg/CoPMMA) (Example A319130-013). In this case, one can see a distinct melt point from the PET, while the Tg is a bit smeared as the materials involved here exhibit Tg's in distinct, but nearby locations, effectively diminishing our ability to see this. In this case, the film has more CoPMMA relative to the PET content. FIG. 9 is a DSC scan of one of our composite 4 layered films (PETg/PET/PETg/CoPMMA) (Example A319131-003). Here, one can see a distinct melt point from the PET, while the Tg is a bit smeared as the materials involved here exhibit Tg's in distinct, but nearby locations, effectively diminishing our ability to see this. In this case, the film has the most CoPMMA relative to the PET content of these 3 composite films (FIGS. 7, 8, and 9).

### Test Method 3 Results: Modulus Measurements

Table 5 shows results from AFM modulus measurements.

TABLE 5
AFM Modulus measurements where the PET Side is the amorphous
layer modulus (A layer), the Core Modulus is B layer,
PET Modulus is A layer, and PMMA side is C layer.

| | PET Side | Core | PET | PMMA Side |
|---|---|---|---|---|
| | Modulus | Modulus | Modulus | Modulus |
| Examples | (GPa) | (GPa) | (GPa) | (GPa) |
| A319129-019 | 1.50 | 3.20 | 2.30 | 3.80 |
| A319130-002 | 1.20 | 1.80 | 1.50 | 2.50 |
| A319130-007 | 2.00 | 2.50 | 1.80 | 3.50 |
| A319130-013 | 1.80 | 2.30 | 1.80 | 2.00 |
| A319131-003 | 1.50 | 1.75 | 1.45 | 1.80 |
| A319131-005 | 1.75 | 4.10 | 3.20 | 3.50 |

In all the samples, the modulus of the semi crystalline PET Core B layer is higher than the corresponding modulus of the amorphous PET A layers. We found that this combination provides the necessary dimensional stability of the film. The amorphous PET tie layers with lower modules provide interlayer adhesion for the film and provide cube fidelity of cast and cure microreplication cubes in the retroreflective sheeting. The modulus of the co-PMMA is not significantly different from the other layers to enable co-extrusion and tentering.

### Test Method 4 Results—Peel Force Measurements

TABLE 6
90 degree peel force measurements (No delam indicates that there was no observed
delamination of the sample.)

| | | | IM MOD | | | |
|---|---|---|---|---|---|---|
| | | | core shell | | | |
| | | | particle, | | | |
| | | Impact | Number of | Average Peel Force (grams) | | |
| Sample | C Layer (100) | Modifier | Layers | Sample 1 | Sample 2 | Sample 3 |
| A319130-002 | CA24 | | NA | 555.8 | 552 | 596.8 |
| A319130-007 | CA24 | | NA | 524.8 | 463 | 475 |
| A319130-008 | CA24 | | NA | 437.3 | 455.1 | 445.5 |
| A319130-013 | TSS #20 | 40 | 2 layer | no delam | no delam | no delam |
| A319131-003 | TSS #21 | 30 | 2 layer | no delam | no delam | no delam |
| A319131-005 | TSS #21 | 30 | 2 layer | no delam | no delam | no delam |
| 15-09935-1A | 510A | 0 | NA | 134 | 142 | 137 |
| 15-09935-8A | 510A | 0 | NA | 122 | 133 | 132 |
| 15-09935-15A | CA-24 | 0 | NA | 140 | 154 | 168 |
| 15-09935-17A | TSS #4 | 20 | 3 layer | 118 | 123 | 117 |
| 15-09935-18A | TSS #5 | 20 | 3 layer | 106 | 107 | 125 |
| 15-09935-20A | TSS #10 | 50 | 2 layer | no delam | no delam | no delam |
| 15-09935-24A | 90% 510A & | 0 | NA | no delam | no delam | no delam |
| | 10% LA 2250 | | | | | |
| 16-11034-1 | CA24 No Tie Layer | 0 | NA | 475 | 465 | 380 |
| 16-11034-2 | CA24 PETG Tie | 0 | NA | 756 | 737 | 763 |
| | Layer | | | | | |
| 16-11034-3 | CA24 PETG Tie | 0 | NA | 605 | 679 | 638 |
| | Layer | | | | | |

We have found that blending acrylic impact modifier particles or ABA block copolymers into an acrylic continuous phase imparts certain elastomeric characteristics to the films. Samples with 30%, 40% & 50% loading of impact modifier particles and the sample with 10% loading of LA2250 do not show any delamination. Samples with no impact modifier particles or with 20% impact modifier particles show delamination between the PMMA and PETG interface.

### Test Method 5 Results: Surface Roughness

TABLE 7
Average and Root Mean Square Surface Roughness, including average and standard
deviation of Ra and Rq measurements for each example.

| | | Ra (nm) | | | Average, | Rq (nm) | | | Average, |
|---|---|---|---|---|---|---|---|---|---|
| Example | Description | 1 | 2 | 3 | Stdev | 1 | 2 | 3 | Stdev |
| A319130- | CA24 | 0.29 | 0.281 | 0.296 | 0.289, | 0.365 | 0.353 | 0.375 | 0.364, |
| 008 | | | | | 0.008 | | | | 0.011 |
| A319130- | TSS #20 | 0.368 | 0.395 | 0.413 | 0.392, | 0.500 | 0.532 | 0.592 | 0.541, |
| 013 | | | | | 0.022 | | | | 0.046 |
| A319131- | TSS #21 | 0.455 | 0.384 | 0.506 | 0.448, | 0.588 | 0.575 | 0.644 | 0.602, |
| 005 | | | | | 0.061 | | | | 0.037 |

Films with CoPMMA TSS #20 and TSS #21 with impact modifier have higher Ra and Rq as compared to film with CoPMMA CA 24 (without impact modifier). We found that films with the impact modifier particles have higher surface roughness than the films without the impact modifier particles. The presence of the impact modified particles allow for better interlayer adhesion with the amorphous PET layer.

1. A film comprising, the following layers in the following order, with each layer being immediately adjacent to the next layer:
a) a first (meth)acrylate layer comprising one or more polymers having a glass transition temperature, Tg, of 80° C. or lower;
b) a first tie layer comprising a copolymer of polyethylene terephthalate having an average refractive index from 1.50 to 1.61, and having a thickness from 0.1 mils to 1 mil;
c) a core layer comprising a homopolymer or copolymer of polyethylene terephthalate having a refractive index in-plane in at least one direction (x or y, or both directions) from 1.60 to 1.72, and a refractive index out-of-plane (z direction) from 1.47 to 1.55,
d) a second tie layer comprising a copolymer of polyethylene terephthalate having an average refractive index from 1.50 to 1.61, and having a thickness from 0.1 mils to 1 mil;
wherein the film is coextruded and biaxially oriented.

2. A film according to claim 1, the core layer comprises a homopolymer or copolymer of polyethylene terephthalate having an identified melt peak in the range from 240° C. to 265° C.

3. A film according to claim 1, wherein the first tie layer and the second tie layer, each, independently of each other, comprises a copolymer of polyethylene terephthalate having an average refractive index of 1.56 to 1.57.

4. A film according to claim 1, wherein the core layer comprises a homopolymer or copolymer of polyethylene terephthalate having a refractive index in plane at least one direction (x or y, or both) from 1.63 to 1.67 and a refractive index out of plane (z direction) from 1.48 to 1.51.

5. A film according to claim 1, further comprising a second (meth)acrylate layer comprising one or more polymers having a glass transition temperature, Tg, of 80° C. or lower, immediately adjacent to the second tie layer, wherein the first (meth)acrylate layer and the second (meth)acrylate layer each comprises, independently from each other, one or more impact modifiers.

6. A film according to claim 5, wherein the loading (W/W) of the impact modifier is chosen from 18% to 60%, 20% to 60%, 25% to 60%, 25% to 55%, 25% to 50%, 25% to 40%, 25% to 30%, 30% to 60%, 30% to 55%, 30% to 50%, 30% to 40%, 20%, 30%, 40%, 50%, and 55%.

7. A film according to claim 1, comprising an ABA block copolymer with polymethylmethacrylate (PMMA) end blocks and a poly (n-butyl acrylate) (PnBA) mid-block.

8. A film according to claim 1, wherein the first tie layer and the second tie layer each has a thickness, independently from each other, from 0.1 mils to 0.5 mils.

9. A film according to claim 1, wherein the first (meth)acrylate layer and the second (meth)acrylate layer each has a thickness, independently from each other, from 0.2 mils to 1 mil and the film has a width from 36 inches to 60 inches.

10. A film according to claim 1, wherein the core layer has a thickness from 0.75 mils to 3 mils.

11. A film according to claim 1, wherein the stretch ratio of the biaxially oriented film in the machine direction is from 1.2 to 4.

12. A film according to claim 1, wherein the stretch ratio of the biaxially oriented film in the transverse direction is from 2.5 to 5.

13. A film according to claim 1, wherein the first (meth)acrylate layer and the second (meth)acrylate layer each comprises, independently from each other, one or more of the following comonomers: ethyl-acrylate and butyl-acrylate.

14. A film according to claim 1, wherein any one of the first and second tie layers, the core layer, and the first and second (meth)acrylate layers, independently from each other, comprises one or more fluorescent compounds.

15. A retroreflective film comprising a film according to claim 1 comprising a prismatic layer.

16. A retroreflective film comprising a film according to claim 1 and further comprising a prismatic layer, wherein the prismatic layer comprises a polycarbonate or a cured acrylic component.

17. A film according to claim 1, further comprising a printed layer immediately adjacent the first (meth)acrylate layer and immediately adjacent the first tie layer.
